(19) United States
(12) Patent Application Publication
(10) Pub. No.: US 2004/0243403 A1
(43) Pub. Date: Dec. 2, 2004

(54) Document relationship inspection apparatus, translation process apparatus, document relationship inspection method, translation process method, and document relationship inspection program

(75) Inventors: Toshihiko Matsunaga, Tokyo (JP); Mihoko Kitamura, Tokyo (JP); Toshiki Murata, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/780,854

(22) Filed: Feb. 19, 2004

(30) Foreign Application Priority Data
May 27, 2003 (JP) 2003-148657

(51) Int. Cl. G06F 17/28

(52) U.S. Cl. 704/209

(57) ABSTRACT

The relationship between documents is detected in consideration of the texts of the documents. A document relationship inspection apparatus which inspects the relationship between constituent elements of a first document and constituent elements of a second document, includes a logical structure parsing section which parses a logical structure of a sentence block including at least one sentence in the constituent elements of the first document and which parses a logical structure of a sentence block including at least one sentence in the constituent elements of the second document, and a relationship detection section which detects the relationship between the sentence block of the first document and the sentence block of the second document on the basis of a parsing result from the logical structure parsing section.

### BACKGROUND OF THE INVENTION

The present invention relates to a document relationship inspection apparatus, a translation process apparatus, a document relationship inspection method, a translation process method, and a document relationship inspection program which are preferably applied to a case in which the relationship of chapters, clauses, sentences, and the like between an old-edition document and a revised-edition sentence (new-revised document) is specified or a case in which a translated a translation process using the specifying result of the relationship is executed.

### DESCRIPTION OF THE RELATED ART

In the technique in “ATLAS V9 New Function “Translation Memory”” (June, 2002) (to be referred to as Non-patent Document 1 hereinafter), a translated original, a parallel translation of a translated section are stored in a parallel-translation database called a “translation memory” in advance. In translation, retrieval of the parallel-translation database is performed, a sentence is compared with an original sentence to be translated (target sentence), and an original sentence having the highest degree of similarity (degree of coincidence) is specified. When the degree of similarity is a threshold value or more, a translated sentence obtained by parallel translating the specified original sentence is output as a translation result of the target original sentence. When the degree of similarity is the threshold value or less, nothing is output, or a mechanical translation result is output.

In order to improve the quality of a translation result obtained by mechanical translation, a large number of essentially difficult problems must be solved. However, when the parallel-translation database is used, a high-quality translation result can be obtained without performing mechanical translation.

When a translation project is performed by a plurality of translators, a way of translating terms can be unified by using the same parallel-translation database. In addition, for example, when a document such as a manual or a technical document the edition of which is known to be revised is used, a first-edition parallel translation is stored in the parallel-translation database to make it possible to efficiently perform a translation operation of revised-edition documents of the second and subsequent editions.

In the method using the parallel-translation database, only the degrees of similarity are inspected in units of sentences. When the degree of similarity is a threshold value or more, a translated sentence stored in the parallel-translation data base is output as a translation result. For this reason, a translation result faithful to a text cannot be obtained. In this sense, it is true that the translation quality is poor.

When viewing from not only a case in which a translation process is performed but also a case in which appropriate and exact edition management, only inspection of the degrees of similarity in units of sentences cannot easily realize high-quality edition management.

It can be abstractly understood that translation of a revised-edition document performed by a parallel-translation database in which a parallel translation related to an old-edition document is included in the concept of edition management. Improvement of the quality of edition management causes improvement of the quality of translation.

### SUMMARY OF THE INVENTION

In order to solve the above problem, the first aspect of the present invention provides a document relationship inspection apparatus which inspects the relationship between constituent elements of a first document and constituent elements of a second document, including: a logical structure parsing section which parses a logical structure of a sentence block including at least one sentence in the constituent elements of the first document and which parses a logical structure of a sentence block including at least one sentence in the constituent elements of the second document; and a relationship detection section which detects the relationship between the sentence block of the first document and the sentence block of the second document on the basis of a parsing result from the logical structure parsing section.

The second aspect of the present invention provides a translation apparatus which uses a parallel-translation dictionary in which a parallel translation between original sentences and translated sentences in a first document is registered to perform a translation process of an original of a second document serving as a revised-edition document obtained by changing at least a part of the first document, including: a document relationship inspection apparatus according to any one of claims 1 to 3; and a block translation process section which executes a translation process using the parallel-translation dictionary to at least a sentence block the relationship of which is detected by the document relationship inspection apparatus in sentence blocks included in an original related to the second document.

Furthermore, the third aspect of the present invention provides a document relationship inspection method which inspects the relationship between constituent elements of a first document and constituent elements of a second document, wherein a logical structure parsing section parses a logical structure of a sentence block including at least one sentence in the constituent elements of the first document and parses a logical structure of a sentence block including at least one sentence in the constituent elements of the second document, and a relationship detection section detects the relationship between the sentence block of the first document and the sentence block of the second document on the basis of a parsing result from the logical structure parsing section.

In the fourth embodiment of the present invention, in a translation process method which uses a parallel-translation dictionary in which a parallel translation between original sentences and translated sentences in a first document is registered to perform a translation process of an original of a second document serving as a revised-edition document obtained by changing at least a part of the first document, wherein a document relationship inspection method according to any one of claims 8 to 10 detects the relationship between the sentence block of the first document and the sentence block of the second document, and a block translation process section executes a translation process using the parallel-translation dictionary to at least a sentence block the relationship of which is detected by the document relationship inspection method in sentence blocks included in an original related to the second document.

Still furthermore, the fifth aspect of the present invention provides a document relationship inspection program which inspects the relationship between constituent elements of a first document and constituent elements of a second document, wherein a computer is caused to realize a logical structure parsing function which parses a logical structure of a sentence block including at least one sentence in the constituent elements of the first document and which parses a logical structure of a sentence block including at least one sentence in the constituent elements of the second document, and a relationship detection function which detects the relationship between the sentence block of the first document and the sentence block of the second document on the basis of a parsing result from the logical structure parsing function.

### BRIEF DESCRIPTION OF THE DRAWINGS

FIG. 1 is a schematic diagram showing an entire configuration of a translation support system according to the first embodiment.

FIG. 2A is a schematic diagram showing a configuration of an original sentence to be processed in the first to fourth embodiments, and is a schematic diagram showing an old-edition original writing OR1.

FIG. 2B is a schematic diagram showing a configuration of an original sentence to be processed in the first to fourth embodiments, and is a schematic diagram showing a revised-edition original writing OR1.

FIG. 3 is a flow chart showing an operation in the first embodiment.

FIG. 4A is a table showing an example of a hierarchical structure of an original sentence used in the first to fourth embodiments, and is a table showing a hierarchical structure of an old-edition original writing OR1.

FIG. 4B is a table showing an example of a hierarchical structure of an original sentence used in the first to fourth embodiments, and is a table showing a hierarchical structure of a revised-edition original sentence OR2.

FIG. 5A is a flow chart showing an operation in the first embodiment.

FIG. 5B is a flow chart showing an operation in the first embodiment.

FIG. 6 is a flow chart showing an operation in the first embodiment.

FIG. 7 is a diagram for explaining an operation in the first embodiment.

FIG. 8 is a diagram for explaining a document structure comparison section used in a translation support system according to the second embodiment.

FIG. 9 is a flow chart showing an operation in the second embodiment.

FIG. 10A is a diagram for explaining an operation in the second embodiment, and a diagram showing the degree of weighting similarity (first) of an original.

FIG. 10B is a diagram for explaining an operation in the second embodiment, and a diagram showing the degree of weighting similarity (second).

FIG. 10C is a diagram for explaining an operation in the second embodiment, and a diagram showing the degree of weighting similarity (third).

FIG. 11 is a diagram for explaining an operation in the third embodiment.

FIG. 12 is a flow chart showing an operation in the third embodiment.

FIG. 13 is a diagram for explaining an operation in the third embodiment.

FIG. 14 is a diagram for explaining an operation in the fourth embodiment.

FIG. 15 is a diagram for explaining operations in the first to fourth embodiments.

FIG. 16 is a diagram for explaining operations in the first to fourth embodiments.

FIG. 17 is a diagram for explaining operations in the first to fourth embodiments, and shows a block combination obtained when hierarchy position i=1.

FIG. 18A is a diagram for explaining operations in the first to fourth embodiments, and a diagram showing a revised edition.

FIG. 18B is a diagram for explaining operations in the first to fourth embodiments, and a diagram showing an old edition.

FIG. 19A is a diagram for explaining operations in the first to fourth embodiments, and a diagram showing a revised edition.

FIG. 19B is a diagram for explaining operations in the first to fourth embodiments, and a diagram showing an old edition.

### DETAILED DESCRIPTION OF THE PREFERRED EMBODIMENTS

Embodiments will be described below with reference to cases in which a document relationship inspection apparatus, a translation process apparatus, a document relationship inspection method, a translation process method, and a document relationship inspection program according to the present invention are applied to a translation support system.

(A) First Embodiment

As described above, in the method described in Non-patent Document 1 using the parallel-translation database, only the degrees of similarity in units of sentences are inspected. When the degree of similarity is a threshold value or more, a translated sentence stored in the parallel-translation database is output as a translation result for this reason, a translation result faithful to a text cannot be obtained. In this sense, it is true that the translation quality is poor.

Even though one sentence has high quality, when connection between sentences or uniformity of a writing style or the like have low quality, a high-quality translation result cannot be obtained. In addition, in order to improve the operating efficiency of edit (post edit) performed by a user after the translation result is obtained, it is preferable that the translation result is faithful to the text.

For example, by using a parallel-translation database in which a parallel translation related to an old edition of a manual or the like is stored, when a revised edition of the manual, it is highly possible that the translation result of the revised-edition manual cannot have high quality without consideration of the texts of the old-edition manual and the revised-edition manual.

In not only a manual but also a document written in, e.g., a natural language, when a distance on the document (A distance can be represented by a unit such as a chapter, a clause, a paragraph, or the like. When the distance is represented by a chapter, for example, a distance is short in the same chapter, and a distance is long in different chapters.) is long, a term or a wording frequently changes depending on various situations. These changes are naturally understood by a reader. For example, when contents which can also be written by the same expression are written twice (2 sentences) in one document, and a short distance between written sentences in the document means that the expressions (terms and wordings) of these sentences frequently coincide with each other. However, when the distance is long, terms and wordings change, and different sentences are not slightly obtained. A similar case is established not only in one document but also between two documents (between an old-edition document and a revised-edition document of the same manual) which are more likely to have a relationship between texts.

For example, when original sentences of a revised-edition manual include a sentence (target original sentence) having a high degree of similarity to an original sentence (reference original sentence) in a parallel-translation group in an old-edition manual, if a text including the target original sentence corresponds to a text including the reference original sentence in the old-edition manual, it is highly possible that a translated sentence obtained by translating the reference original sentence can be directly used as a translation result. When the texts do not correspond to each other, it is unlikely that the translated sentence can be directly used as a translation result. In addition, although a text does not correspond to the text including the reference original sentence, the text is used as a translation result, the necessity of considerably changing the text in post edit is expected to be high. However, in the technique in the Non-patent Document 1 which does not concern texts, there is no method of informing a user of the necessity. For this reason, a user must eventually perform a post edit operation with carefulness almost equal to that of a post edit operation for a translated sentence having a low degree of similarity, and the operating efficiency of the post edition is poor.

Therefore, this embodiment is characterized in that the quality of a translation result is improved by performing translation faithful to a text.

(A-1) Configuration of First Embodiment

An entire configuration of a translation support system 10 according to this embodiment.

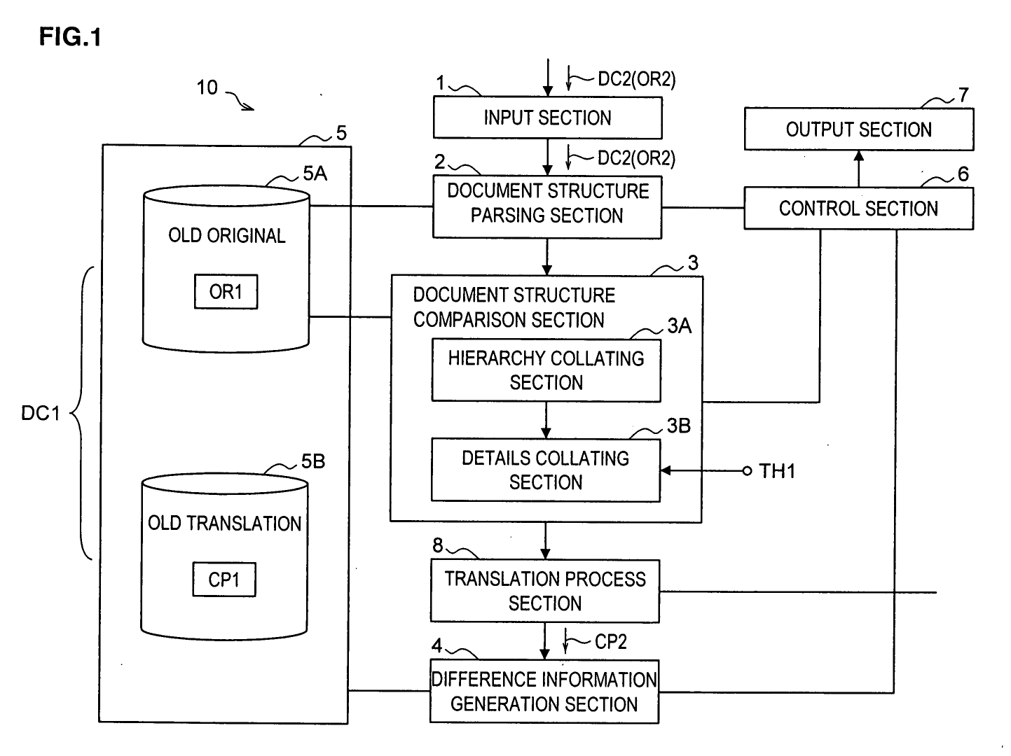

In FIG. 1, the translation support system 10 comprises an input section 1, a document structure parsing section 2, a document structure comparison section 3, a difference information generation section 4, an old-edition database 5, a control section 6, an output section 7, and a translation process section 8.

The input section 1 of these components is, for example, a component such as a pointing device such as a keyboard or a mouse, a scanner, a character recognizing process, or the like which is constituted by various functions, and functions when a user performs various input operations.

The output section 7 is, for example, a component which can be constituted by various functions such as a display function on a display device, a converting function to sound, and a sound output function. The output section 7 provides various pieces of information to the user. In this case, the user may be an operator who operates the translation support system 10.

The input section 1 and the output section 7 functions as not only an interface with the user which is a human being, but also a component which exchanges control information or data with a remote or local information processing device (not shown). Depending on the exchange with the user or the information processing device, the storage contents in the old-edition database 5 may be increased/decreased or changed. The main body of the old-edition database 5 is arranged on a Web server side, and only a retrieval result (or only a translation result) may be obtained by the translation support system 10 through a network. In order to obtain only a retrieval result, retrieval is performed by using a CGI program or the like on the Web server side, and the result may be transmitted to the translation support system 10.

The control section 6 is a section which corresponds to a CPU (Central Processing Unit) of the translation support system 10 in hardware and which corresponds to various programs such as an OS (Operating System) in software. The other components 1 to 5, 7, and 8 in the translation support system 10 can be controlled by the control section 6.

The old-edition database 5 itself is designed such that an original sentence (of one sentence) is basically designated by a component corresponding to the parallel-translation database to make it possible to extract the translated sentence (of one sentence). However, since a method of using the parallel translation in this embodiment is different from that in the Non-patent Document 1, depending on the difference, the storage contents in the database are partially different from conventional storage contents. In the old-edition database 5, for example, an old edition (for example, first edition) of a document expected to be revised such as a manual, a technical document, or an article is stored. In the old-edition database 5, a plurality of old-edition documents (for example, an old-edition document of a manual related to a personal computer of a certain machine type, an old-edition document of a manual related to a personal computer of another machine type, and the like) can be simultaneously stored. In the following description, explanation will be performed while giving attention to one document DC1 stored in the old-edition database 5.

In general, one original writing and a translated writing obtained by translating the original sentence as a translation result are recognized as independent writings. However, the document DC1 is one parallel-translation document including the contents of an original writing (OR1) and the contents of a translated writing (CP1).

The original writing is a set of sentences ordered to express contents in a first language (original-writing language (for example, Japanese)). The translated writing is a set of sentences ordered to express contents in a second language (translated-writing language (for example, English)). In general, sentences in the original writing and the sentences in the translated writing do not have one to one correspondence. However, since the document DC1 is a parallel-translation document, the sentences in the original writing OR1 and the sentences in the translated document CP1 have one to one correspondence. Therefore, from the viewpoint of a text (text also corresponds to a hierarchical structure (to be described later)9, the original writing OR1 and the translated writing CP1 exactly correspond to each other.

The contents in the old-edition database 5 can be divided into an old-edition original database 5A in which the original writing OR1 is stored and an old-edition translation database 5B in which the translated writing CP1 is stored.

The document structure parsing section 2 is a section which parses the structure of a document and which supplies the parsing result to the document structure comparison section 3. In this case, the structure means a natural-linguistic and logical structure of a writing, and indicates a structure related to positions and inclusive relations of chapters, clauses, paragraphs, sentences, and the like in one writing. In many cases, a writing such as the manual, a technical document, or an article in which a logical structure is relatively clear comprises the following hierarchical structure. That is, one writing includes a plurality of chapters, each chapter includes one clause or a plurality of clauses, each clause includes one paragraph or a plurality of paragraphs, and each paragraph includes one sentence or a plurality of sentences. Therefore, the role of the document structure parsing section 2 is to parse the hierarchical structure.

In this case, a chapter, a clause, and a paragraph is called a block which means a set of at least one sentence. The sentence can also be included in the concept of the block. However, in this case, it is assumed that the concept of the block does not include a sentence. These blocks have the hierarchical structure. In general, one clause includes one paragraph or a plurality of paragraphs. However, in this case, the paragraph is neglected for descriptive convenience. It is assumed that a sentence is directly included in the block of a clause.

Documents to be parsed by the document structure parsing section 2 include a revised-edition original writing OR2 which is a writing in the revised-edition document DC2 input through the input section 1 and an old-edition original writing OR1 included in the old-sentence document DC1. However, since the old-edition original writing OR1 has predetermined contents, the old-edition original writing OR1 is parsed before the revised-edition original writing OR2 is obtained, and a parsing result can be stored in the old-edition original database 5A. This point is the same as that of the old-edition translated writing CP1. In order to improve processing efficiency, it is preferable that the hierarchical structures of the old-edition original writing OR1 and the old-edition translated writing CP1 are parsed in advanced and stored in the old-edition database 5 or the like.

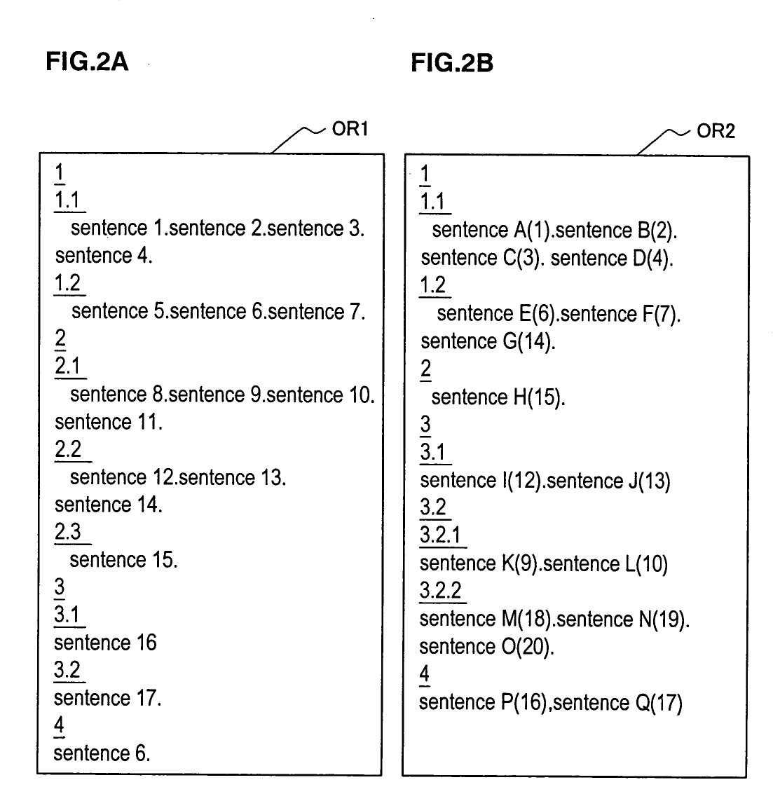

FIG. 2A is obtained by abstracting an example of the contents of the old-edition original writing OR1. Similarly, FIG. 2B is obtained by abstracting an example of the contents of the revised-edition original writing OR2.

In FIGS. 2A and 2B, understroked “1” or “2” is the number of a chapter. Furthermore, in “1.1” or “2.2”, the left number denotes the number of a chapter, and the right number denotes the number of a clause included in the chapter. Therefore, for example, “1.1” denotes the first clause in the first chapter.

In FIG. 2A, “sentence 1”, “sentence 2”, or “sentence 5” denotes a sentence included in each clause. In this case, the difference/coincidence of a number (sentence identifier) following the “sentence” expresses the difference/coincidence of a character string constituting the contents of the sentences. Therefore, “sentence 1” and “sentence 2” are different sentences. In FIG. 2A, for example, both the second clause in the first chapter and the fourth chapter include the same sentence indicated by “sentence 6”.

FIG. 2B showing the revised-edition original writing OR2 is basically the same as FIG. 2A. The two writings correspond to the old edition and the revised edition of the same writing (for example, a manual related to a personal computer of the same machine type). For this reason, the two writings OR1 and OR2 include common parts in the contents.

In FIG. 2B, like “sentence A” or “sentence B”, alphabets are used as sentence identifiers in place of numbers. A number in parentheses such as “sentence A(1)” or “sentence B(2)” denotes a sentence identifier on the old-edition original writing OR1 side shown in FIG. 2A, and represents the relationship between a sentence in the old edition and a sentence in the revised edition.

In this embodiment, as identification information for identifying a sentence, not only the sentence identifier, but also a sentence number are used. The sentence identifier is information for identifying a character string constituting the contents of a sentence. On the other hand, the sentence number is information representing an order of sentences appearing in the writing.

As described above, the sentence numbers are given to sentences in order (order from the top in FIG. 2A or 2B) of appearing in each original writing. For this reason, sentences (sentences to which the same sentence identifier is applied) having he same character string have different sentence numbers when the positions of the sentences are different from each other. Therefore, different sentence numbers are applied to the “sentence 6” appearing in the second clause in the first chapter and the “sentence 6” appearing the fourth chapter.

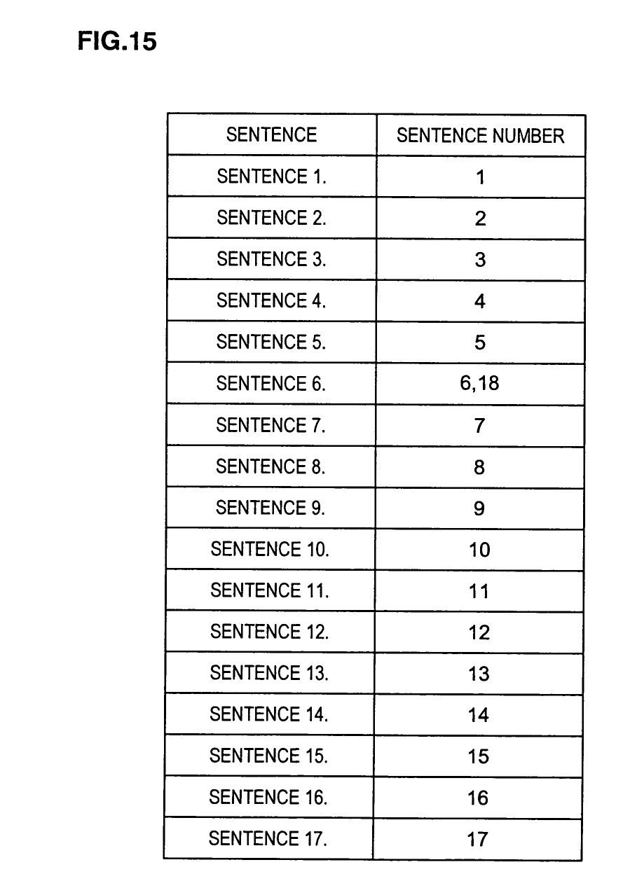

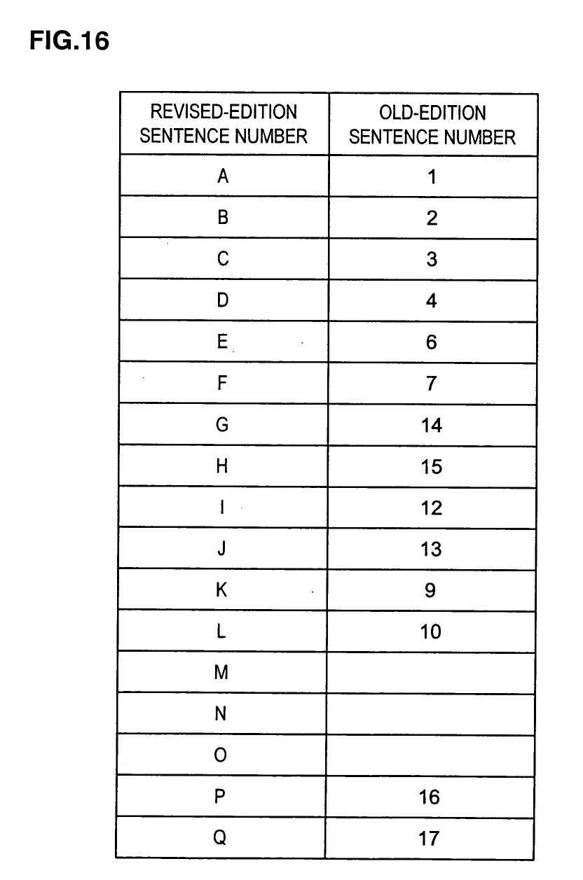

The relationship between the sentence of the old-edition original writing OR1 and the sentence number in FIG. 2A is given by a sentence-sentence number corresponding table shown in FIG. 15. When the relationships between the sentences of the old-edition original writing OR1 and the sentences of the revised-edition original writing OR2 are arranged on the basis of sentence numbers, a new-old sentence corresponding table shown in FIG. 16 is obtained.

It is desirable for simplifying a parsing process performed by the document structure parsing section 2 that the revised-edition document DC2 or the old-sentence document DC1 is a document (for example, a document such as an HTML document or an XML document written in a markup language) in which a logical structure is clearly specified by a predetermined routine method. However, the revised-edition document DC2 or the old-sentence document DC1 are not necessarily the document.

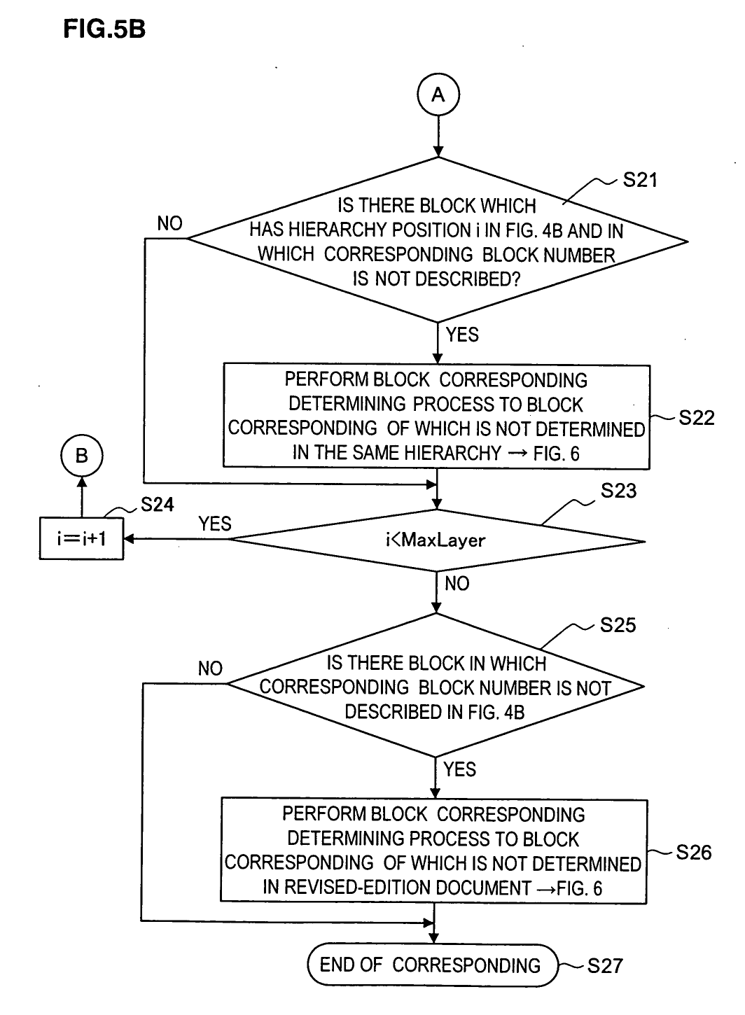

On the basis the writings in FIGS. 2A and 2B, a parsing result obtained by the document structure parsing section 2 can be regulated into the form of structure information tables shown in FIGS. 4A and 4B. FIG. 4A is obtained by regulating a parsing result related to the old-edition original writing OR1, and FIG. 4B is obtained by regulating a parsing result related to the revised-edition original writing OR2.

In FIGS. 4A and 4B, block numbers are numbers given to the blocks in orders of the blocks appearing in the original writings. The hierarchy position means a depth of hierarchy. The hierarchical structure can be expressed by a tree structure. When a depth of 0 represents a root of a tree corresponding to the entire writing (for example, the whole of the old-edition original writing OR1, a depth of 1 represents a node of a tree corresponding to the chapter, and a depth of 2 represents a node of a tree corresponding to the clause.

A lower block number is a block number which is deeper than each block by a depth of 1 and which belongs to each block. A sentence number is a sentence number of a sentence which belongs a block designated by the relationship block number.

The relationship block number and the degree of similarity are the block number of a block in which the relationship between the old-edition original writing OR1 and the revised-edition original writing OR2 can be fixed and the degree of similarity which is the grounds for the fixation. As will be described later with respect to the details of the degree of similarity, there is no block in which relationship has not been fixed in the illustrated state. For this reason, the columns for relationship block number and degree of similarity are blank.

As the contents of the relationship block number and the degree of similarity, contents which correspond to each other (symmetrical contents) are written. For this reason, “relationship block number and degree of similarity” serving as data items need not be set in both FIGS. 4A and 4B. For example, the data items may be set in only the FIG. 4B.

The document structure comparison section 3 is a section which compares the logical structures of the revised-edition original writing OR2 and the old-edition original writing OR1 by using the hierarchical structure serving as the parsing result of the document structure parsing section 2. When both the logical structures are compared with each other, as a translated sentence of the block of the revised-edition original writing OR2 which is confirmed to correspond to the block at a sentence level, the contents of the block of the old-edition translated writing CP1 can be directly used, and translation using parallel translation can be advantageously performed.

In order to perform this comparison, the document structure comparison section 3 comprises a hierarchy collating section 3A and a details collating section 3B.

The hierarchy collating section 3A is a section which compares the depths in the hierarchical structures of the revised-edition original writing OR2 and the old-edition original writing OR1 each other. The depth in the hierarchical structure is changed by revising the edition. For example, as indicated by “3.2.1” and “3.2.2” in “3.2” in FIG. 2B, a new hierarchy (subsidiary clause) may be arranged between the clause and the sentence. However, in order to perform the process in the details collating section 3B, the depths in the hierarchical structures must be leveled. For this reason the hierarchy collating section 3A is required. Depending on the concrete specification of a process performed by the details collating section 3B, the hierarchy collating section 3A may be omitted.

The details collating section 3B is a section which inspects the relationship between the old-edition original writing OR1 and the revised-edition original writing OR2. For this inspection (i.e., block correspondence determining process), the details collating section 3B inspects the difference/coincidence (difference/coincidence of character strings of sentences) of sentences between the old-edition original writing OR1 and the revised-edition original writing OR2. The details collating section 3B receives a setting of a threshold value TH1 serving as a reference when it is identified whether the blocks correspond to each other or not. As will be described later, when the degree of similarity has a maximum value of 100% and a minimum value of 10%, the threshold value TH1 is set at an intermediate value between 100% and 0%. The threshold value TH1 may be determined in any manner. For example, the threshold value TH1 may be set at 40%.

The degrees of similarity of combinations of all the blocks of the writings OR1 and OR2 at the same hierarchy position are calculated, the relationships between blocks are determined on the basis of the degrees of similarity.

The degree of similarity is calculated to retrieve one block in the old-edition original writing OR1 corresponding to a block (i.e., node of a tree) in the revised-edition original writing OR2. For this reason, this combination is naturally a combination constituted by one pair of blocks.

The degree of similarity may be calculated by any calculation method which can represents the degree of similarity of one pair of blocks. However, the degree of similarity is easily calculated according to the following equation (1).

100×(the number of sentences which completely coincide with each other)/(the total number of pairs of blocks)/2)) (1)

In FIGS. 2A and 2B, when a hierarchy position 2 is examined, for example, when a combination between the first clause in the first chapter of the old-edition original writing OR1 and the first clause in the first chapter of the revised-edition original writing OR2 is selected as one pair of blocks, the total number of blocks in equation (1) is given by 8 (=4+4), and the number of sentences which completely coincide with each other is 4. For this reason, the degree of similarity is 100%.

Similarly, when a combination between the second clause in the first chapter of the old-edition original writing OR1 and the first clause in the first chapter of the revised-edition original writing OR2 is selected as one pair of blocks, the total number of blocks in equation (1) is given by 7 (=3+4), and the number of sentences which completely coincide with each other is 0. The same inspection as described above is executed with respect to all combinations related to the blocks at the document structure parsing section 2. The same processes as described above are performed with respect to different hierarchy positions.

In equation (1), with respect to only a change in the same block, a change (change of a relative appearance position) of an appearance position of a sentence is not reflected. However, in the revised edition, a position where a sentence appears may change even though the character string of the sentence does not change. For this reason, the change of such a position is desirably reflected on the degree of similarity.

With respect to the cases shown in FIGS. 4A and 4B, for example, combinations of blocks at the hierarchy position 2 will be cited according to the form (block number of a block in the writing OR1, block number of a block in the writing OR2). That is, the combinations are (2,2), (2,3), (2,6), (2,7), (3,2), (3,3), (3,6), (3,7), (5,2), . . . , (10,6), and (10,7).

When the edition is revised, a new chapter or clause which does not exist in the old edition (for example, OR1) appears in the revised-edition writing (for example, OR2), or the contents of the chapter or the clause may be partially changed. However, in the new chapter or clause appearing in the writing, the details collating section 3B determines that the old-edition original writing does not include corresponding blocks. When the contents of the chapter or clause are partially changed by revising the edition, although the old-edition original writing includes corresponding blocks, the degree of similarity between the blocks is low.

When the degree of similarity between combinations is simply calculated according to the equation (1), the relationship between the blocks can also be determined (including determination that corresponding blocks do not exist). However, the details collating section 3B according to this embodiment sequentially calculates the degrees of similarity from a shallow hierarchy position. When the degree of similarity is calculated at a deep hierarchy position, the result obtained by equation (1) is not directly used. The result is changed depending on an inspection result of the relationship blocks at a shallow hierarchy position to which the position at a deep hierarchy position belongs (when viewing from the block at the deep hierarchy position, the block at the shallow hierarchy position corresponds to a master block (upper block)).

This change is realized by the following control. That is, the degree of similarity of a block belonging to a block (relationship-unfixed block) the corresponding block of which is not determined not to exist is lower than the degree of similarity of a block belonging to a block (relationship-fixed block) the relationship of which can be determined. This control may be performed by, for example, multiplying the degree of similarity calculated by equation (1) by a predetermined coefficient ρ (0<ρ<1). In addition, the concrete value of ρ may be, 0.8 or 0.9. The coefficient p may have only one value or a plurality of values.

When the coefficient p has a large number of values, even in a block belonging to a relationship-fixed block (When viewed from this block, the relationship-fixed block corresponds to a master block (upper block). In contrast to this, when viewed from the relationship-fixed block serving as a master block, a block belonging to the relationship-fixed block corresponding to a subsidiary block), the value of ρ is changed depending on the degree of similarity which is the grounds for determining the relationship of the relationship-fixed block. This is, the degree of similarity serving as the grounds is small, the value of the coefficient ρ to be multiplied is decreased, so that the degree of similarity calculated by equation (1) is decreased.

For this reason, by the relationship between the master blocks of the original writing OR1 and the original writing OR2, the relationship between subsidiary blocks is regulated. For this reason, the possibility of fixing the relationship between subsidiary blocks beyond the range of the master block can be reduced in a probabilistic manner. This means the followings. That is, even in a case in which a sentence is partially changed by revising an edition to decrease the degree of similarity between the sentences of the old edition and the revised edition, when the entire text is not largely changed, the sentences between the old edition and the revised edition can be caused to correspond to each other. In the technique in the Non-patent Document 1, in such a case, translation by parallel translation cannot be performed. However, in this embodiment, in such a case, translation by parallel translation can be performed.

As a matter of course, as far as the writing is concerned, the translation result is not correct. However, the translation result can be efficiently corrected by post edit.

The translation process section 8 is a section which executes a translation process of the revised-edition original writing OR2 in response to the process in the document structure comparison section 3. The translation process section 8 outputs the revised-edition translated writing CP2 which is a translation of the revised-edition original writing OR2 according to the translation process.

In this embodiment, the translation of the revised-edition original writing OR2 is mainly executed by replacing a block in the revised-edition original writing OR2 with a block in the old-edition translated writing CP1. Since the old-edition original writing OR1 exactly corresponds to the old-edition translated writing CP1, a relationship-fixed block in the revised-edition original writing OR2 must have a corresponding block in the old-edition translated writing CP1. As the block in this case, a block the hierarchy of which is low as much as possible (for example, a block of a clause) is desirably used.

Since a relationship-unfixed block in the revised-edition original writing OR2 does not have a corresponding block in the old-edition translated writing CP1, translation performed by replacing blocks cannot be performed. Therefore, in translation of the relationship-unfixed block in the revised-edition original writing OR2, for example, normal mechanical translation is used, or, as is performed in the Non-patent Document 1, on the basis of the degree of similarity of sentences, translation by parallel translation using the old-edition database 5 in units of sentences (not blocks).

In the normal mechanical translation, by using process results of known various processes such as a morphological parsing process or a syntax parsing process, a translation process is dynamically executed.

Even in a block in which the degree of similarity is not 100%, translation by parallel translation is performed without performing mechanical translation as far as possible, so that the operating efficiency of post edit can be improved. The translation by parallel translation is better than the translation by mechanical translation in connection between sentences and uniformity of a writing style.

The difference information generation section 4 is a section which outputs information (auxiliary information) corresponding to a difference between the old-edition translated writing CP1 and the revised-edition translated writing CP2. This auxiliary information can designates a block in the old-edition original writing OR1 or the old-edition translated writing CP1 deleted by revising the edition on, e.g., the display screen of the display device, and can also be used to designate a block subjected to mechanical translation in the revised-edition translated writing CP2. The block subjected to the mechanical translation is a block having a high necessity of being subjected to post edit. Even though the revised-edition translated writing CP2 is a long writing, the user who watches the auxiliary information on the screen can perform the post edit while giving attention to only a block designated by the auxiliary information. For this reason, the efficiency of the post edit increases.

The old-edition database 5 is naturally constructed on a storage resource such as a nonvolatile storage means such as a hard disk or an optical disk or a volatile storage means such as a memory.

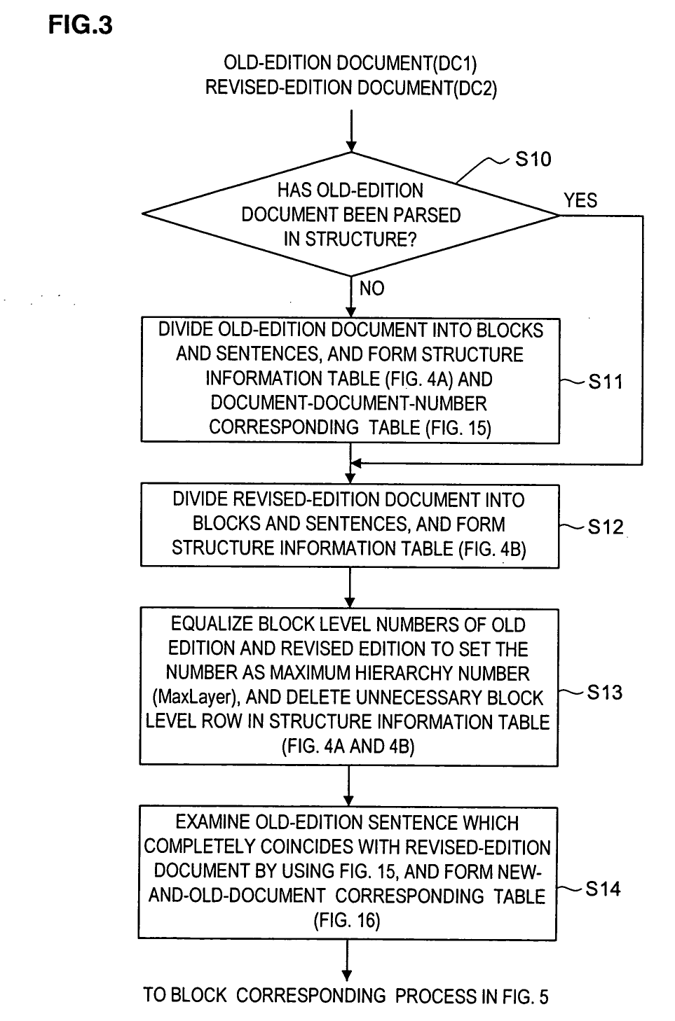

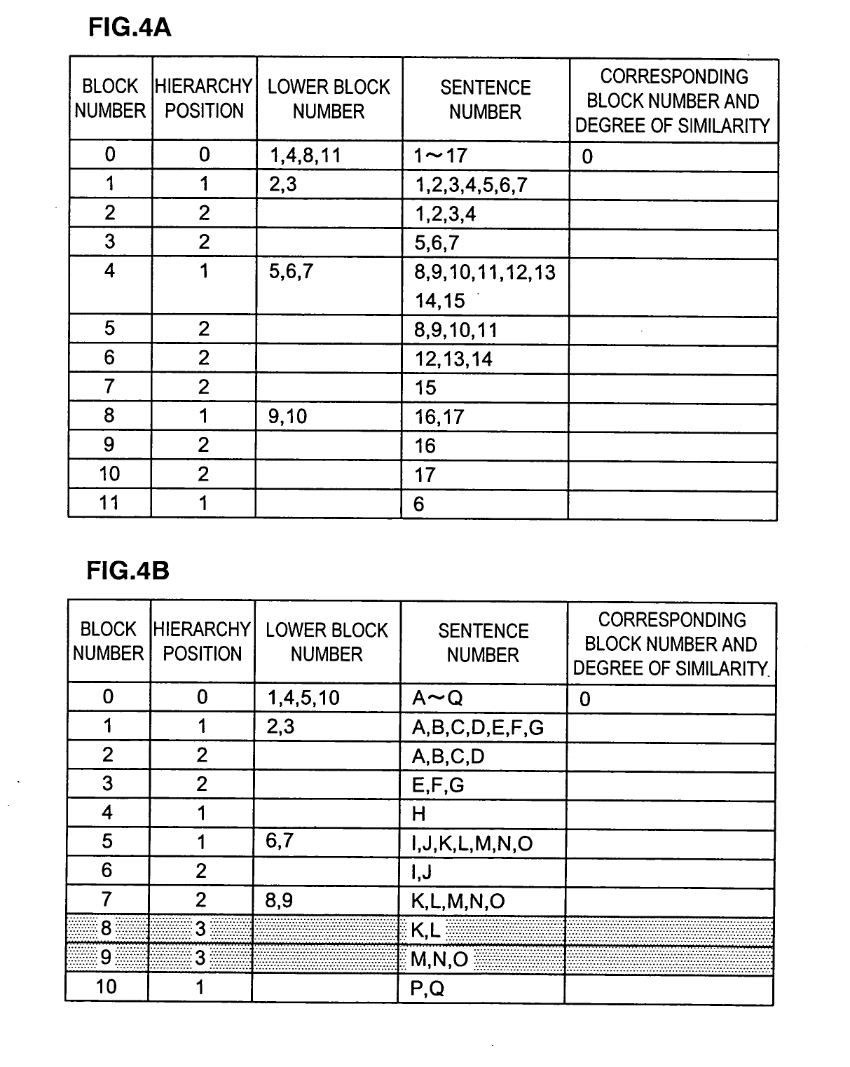

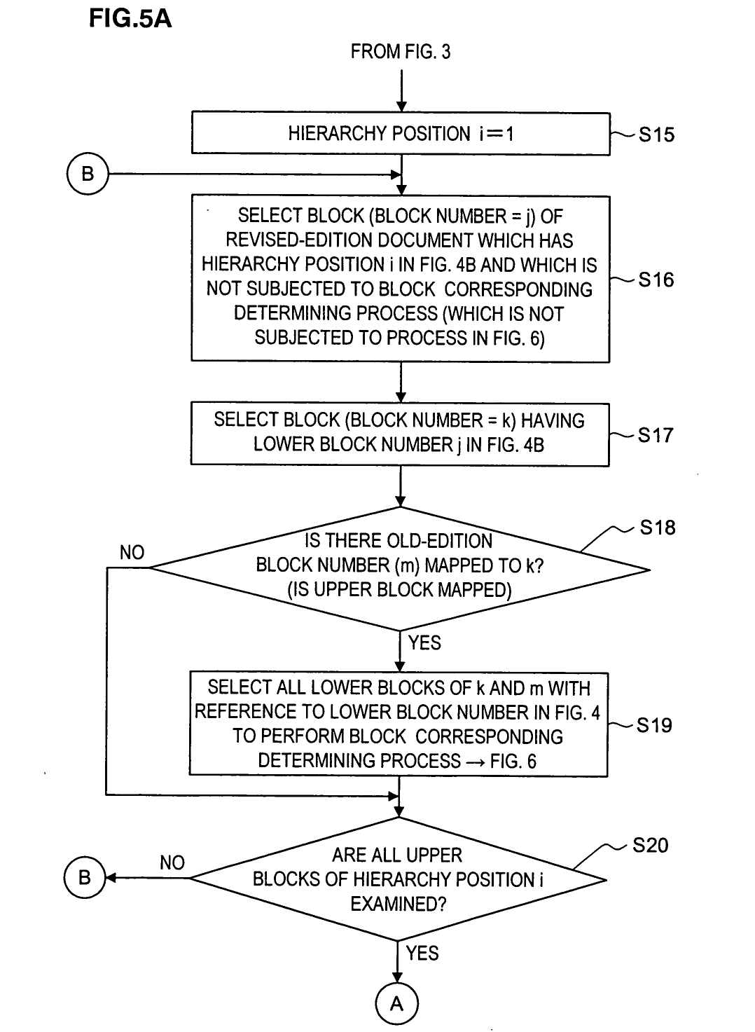

An operation of this embodiment having the above configuration will be described below with reference to the flow charts shown in FIGS. 3, 5, and 6.

The flow charts in FIGS. 3 and 5 show a flow of one series of entire processes. After the processes of the flow chart in FIG. 3, the processes of the flow chart in FIGS. 5A and 5B are executed. The flow chart in FIG. 3 is constituted by steps S10 to S14. The flow chart in FIGS. 5A and 5B is constituted by steps S15 to S27.

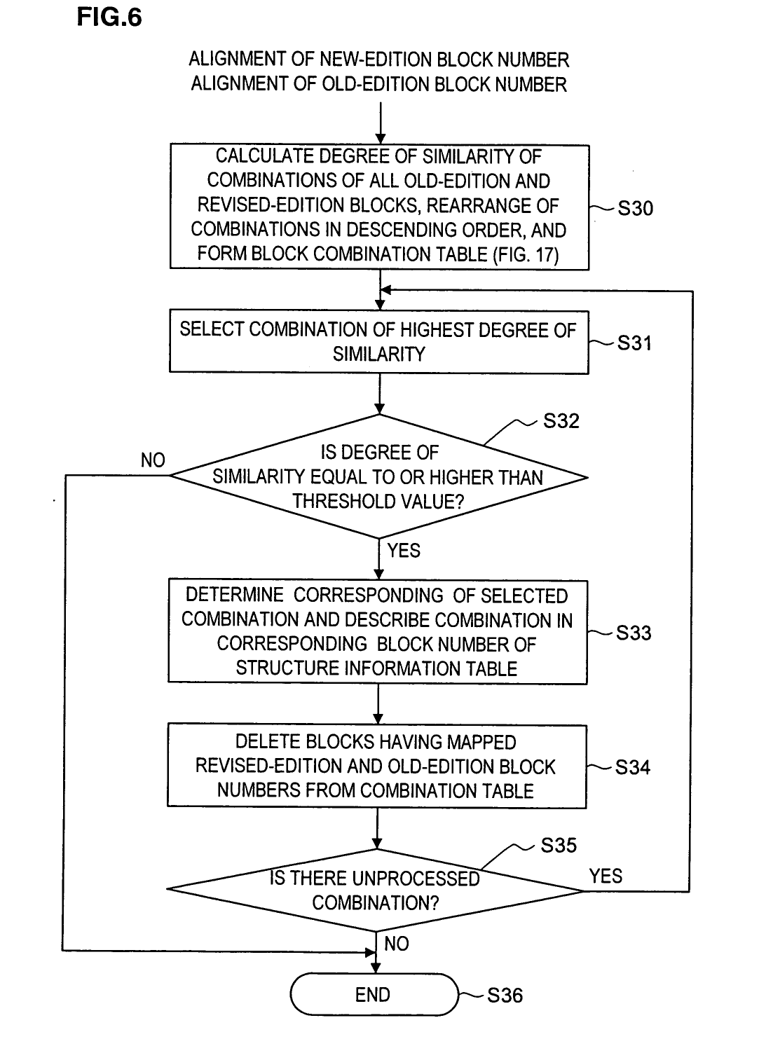

The flow chart in FIG. 6 is a flow chart showing the details of inspection (block relationship determining process) of the relationship between blocks performed by the details collating section 3B, and is constituted by steps S30 to S36. In relation to FIGS. 5A and 5B, the flow chart in FIG. 6 shows the detailed operations in step S19, S22, or S26 in FIGS. 5A and 5B.

As is apparent from the above explanation, the flow charts in FIGS. 3, 5, and 6 include processes executed in relation to the old-edition original writing OR1 and the revised-edition original writing OR2.

(A-2) Operation of First Embodiment

In FIG. 3, it is assumed that, when the old-edition original writing OR1 included in the old-sentence document DC1 such as a manual and the old-edition translated writing CP1 are stored in the old-edition database 5, the revised-edition document DC2 including the revised-edition (new-edition) original writing OR2 as contents is supplied from the input section 1. This supply is performed together with a command to request translation of the revised-edition original writing OR2 from the translation support system 10.

In this embodiment, in order to cause the translation support system 10 to process the writings OR1 and OR2, the two writings must be parsed by the document structure parsing section 2 and arranged in a form of the structure information tables shown in FIGS. 4A and 4B. As described above, when the old-edition original writing OR1 is parsed in advance to obtain the hierarchical structure thereof, parsing need not be performed. Otherwise parsing is performed to obtain the structure information table in FIG. 4A (S10 and S11). At this time, a sentence-sentence number corresponding table in FIG. 15 is also obtained.

Various parsing processes are performed to the revised-edition original writing OR2 to obtain the structure information table in FIG. 4B (S12).

A value at the deepest hierarchy position in a shallower hierarchical structure of the hierarchical structures of the writings OR1 and OR2 is substituted for a maximum hierarchy variable MaxLayer representing the maximum number of hierarchies. This operation is performed to coordinate the depths of the hierarchical structures of the two writings OR1 and OR2 with the depth of the shallow one. At the same time, an unnecessary block level row of the hierarchical structure table is deleted (S13). This deletion is performed when the depths of the two writings OR1 and OR2 are not leveled. In the examples in FIGS. 2A and 2B, with this deletion, two rows in FIG. 4B corresponding to “3.2.1” and “3.2.2” in FIG. 2B are deleted, and the maximum hierarchy variable MaxLayer is substituted for 2.

Sentences in the old-edition original writing OR1 which completely coincide with the sentences in the revised-edition original writing OR2 are examined by using the sentence-sentence number corresponding table shown in FIG. 15, and the new-sentence-old-sentence corresponding table shown in FIG. 16 is formed (S14).

Subsequent to the step S14, in step S15 in FIGS. 5A and 5B, the inspection hierarchy variable i is substituted for 1. This variable i is a variable representing a hierarchy position at which the relationship between blocks. As described above, since the difference between hierarchy positions is not reflected on a block number itself, a hierarchy position subjected to a block relationship determining process performed by the details collating section 3B must be controlled by the inspection hierarchy variable i. In other words, when a block number on which the difference between hierarchy positions is reflected is given, the contents in the flow chart in FIGS. 5A and 5B may be considerably changed.

In the step S15, when the inspection hierarchy variable i is substituted for 1, inspection (block relationship determining process) of the relationship between blocks at a hierarchy position 1, i.e., at a level of the chapter is started. As described above, although 0 may be used as the hierarchy position, an initial value set here is 1.

All the combinations are processed with respect to blocks at the hierarchy position i. For this reason, a block (the block number of this block is j) which is not subjected to the block relationship determining process and an upper block (the block number of this block is k) the lower block of which has block number j are selected (S17).

It is inspected whether a block (the block number of this block is m) corresponding to the upper block having block number k exists on the old-edition original writing OR1 side or not (S18). If YES in step S18, all lower blocks (subsidiary blocks) the master blocks of which are the upper blocks having the block numbers of k and m are selected. The block relationship determining process is performed to the lower blocks (S19). If NO in step S18, the control flow shifts to step S20.

When the hierarchy position is 1, the upper block (master block) is only a block at a hierarchy position 0, i.e., only a block including the entire original writing. The writings DC1 and DC2 have the same relationship between an old edition and a revised edition of the same document such as a manual related to a personal computer of a certain machine type. For this reason, in the processes performed when the hierarchy position i is 1, YES is naturally determined in step S18 without any condition.

In step S20, it is checked whether the block relationship determining process is performed with respect to all the upper blocks (all the master blocks) to the blocks at the hierarchy position i in the revised-edition original writing OR2. When the block relationship determining process is not performed some master block, the control flow returns to the step S16 to repeat the same processes. When the block relationship determining process for all the master blocks is completed, the control flow shifts to step S21. In step S21, it is checked whether the columns for relationship block number and degree of similarity are blank or not in corresponding rows (corresponding block) of the structure information table in FIG. 4B. Since the row having the columns which are blank is a row of a block (relationship-undetermined (relationship-unfixed) block) which is not subjected to the block relationship determining process, the block relationship determining process is performed to the row (S22).

When the relationships (relationship-fixed block or relationship-unfixed block) of all the blocks at the hierarchy position i, it is inspected whether the value i at this time is smaller than the value of the maximum hierarchy variable MaxLayer or not (S23). If the value i is smaller than the maximum hierarchy variable MaxLayer, YES is determined in step S23, the value i is incremented (S24), and the control flow returns to step S16. If the value is not smaller than the maximum hierarchy variable MaxLayer, NO is determined in step S23, and the control flow shifts to step S25. In this case, since the maximum hierarchy variable MaxLayer is 2, when the value i is 1, YES is determined in step S23.

In step S25, as in the step S21, it is checked whether a block having the columns for relationship block number and degree of similarity which are blank exists or not. If YES in step S25, the block relationship determining process is executed to the block. Since the process in step S26 is executed after NO is determined in step S23, the relationship between the blocks (i.e., clauses) at the deepest hierarchy position 2 is determined, and the relationships of all the blocks included in the revised-edition original writing OR2 are fixed.

As a matter of course, with this fixation, the relationship-unfixed block which does not correspond to any block (which has no relationship block) may naturally appear.

The details of the block relationship determining process corresponding to the detailed operations in steps S19, S22, and S26 will be described below with reference to the flow chart in FIG. 6.

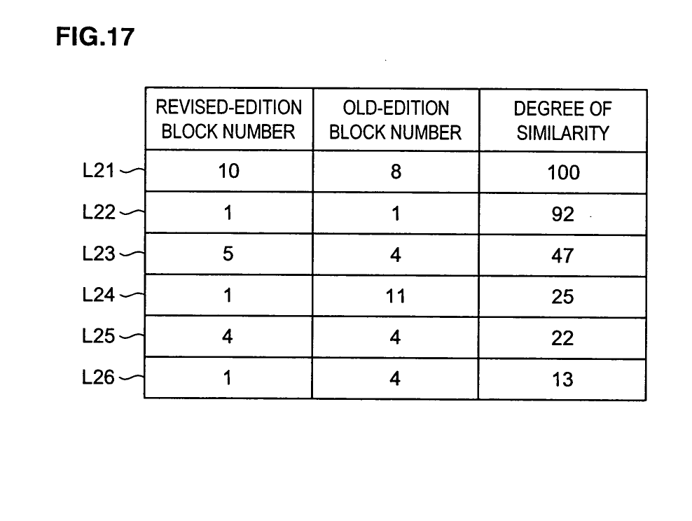

In FIG. 6, since a hierarchy position where the processes are performed and the like have been determined, combinations of all the blocks at the hierarchy position are obtained. With respect to the combinations, the degrees of similarity according to the equation (1) are calculated, and the combinations of blocks are arranged in a descending order of the degrees of similarity to form a block combination table shown in FIG. 17 (S30). As has been described above, although the degrees of similarity are simply calculated according to equation (1), the degrees of similarity may also be multiplied by the coefficient ρ.

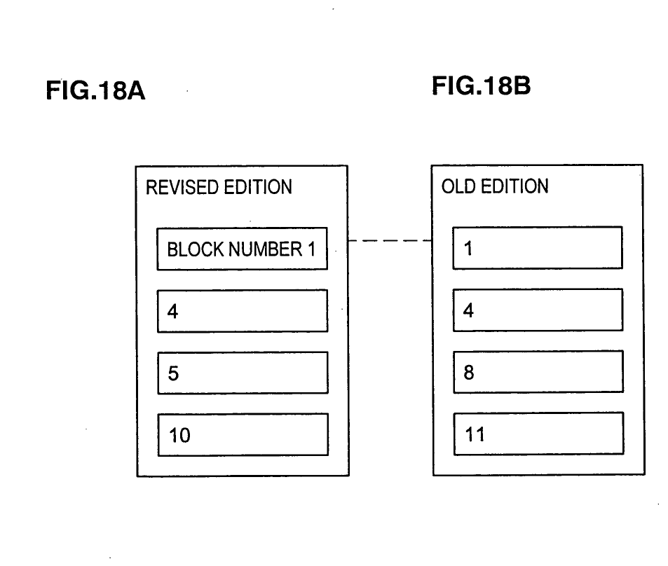

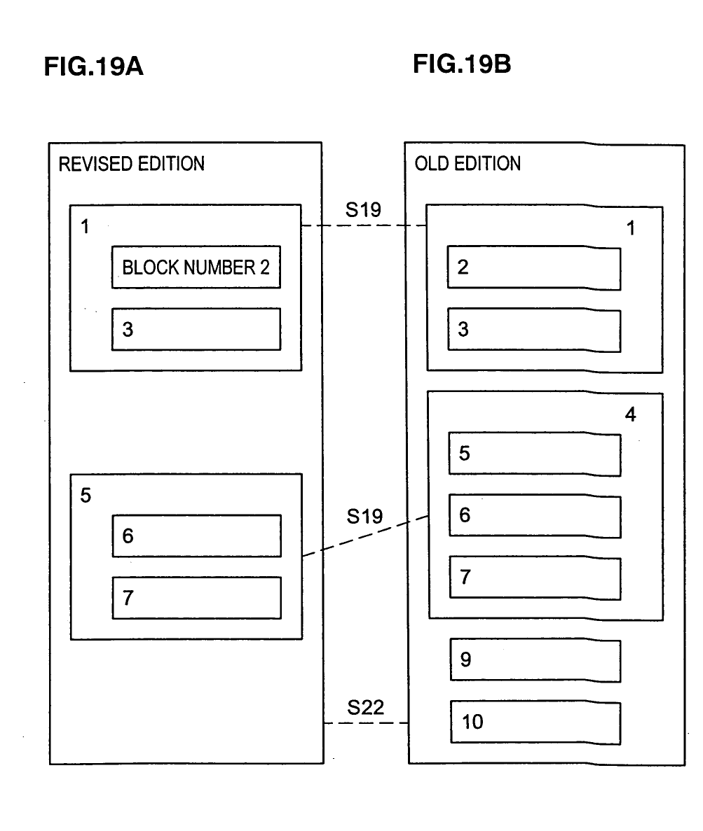

FIG. 17 is a block combination table obtained when a hierarchy position based on the structure information tables in FIGS. 4A and 4B is 1. As is also apparent from FIG. 18, blocks having block numbers 1, 4, 8, and 11 exist at the hierarchy position 1 in FIG. 4A, and blocks having block numbers 1, 4, 5, and 10 exist at the hierarchy position 1 in FIG. 4b. Relationships similar to the relationship in FIGS. 4A and 4B are also illustrated in FIGS. 19A and 19B. As is apparent from FIG. 19A, for example, the blocks (clauses) having block numbers 2 and 3 belong to the block (chapter) having block number 1 in the revised-edition original writing OR2, and the blocks having block numbers 6 and 7 belong to the block having block number 5. Similarly, in FIG. 19B the blocks (clauses) having block numbers 2 and 3 belong to the block (chapter) having block number 1 of the old-edition original writing OR1, and the blocks having block numbers 5, 6, and 7 belong to the block having block number 4.

The contents of the block combination table shown in FIG. 17 are written according to the form (block number of a block in the old-edition original writing OR1, block number of a block in the revised-edition original writing OR2). The uppermost row L21 of the combinations of blocks formed in step S30 is represented by (8, 10), and the second and subsequent rows L22 to L26 are sequentially represented by (1, 1), (4, 5), (11, 1), (4, 4), and (4, 1).

A row (in this case, L21) corresponding to a combination having the highest degree of similarity is selected from the rows of the block combination table (S31). It is inspected whether the degree of similarity of the row is a predetermined TH1 or more or not (S32).

Even in the combination having the highest degree of similarity, when the threshold value TH1 which is smaller than 1 means that blocks related to each other do not exist. For this reason, the relationship-fixed block cannot be obtained, and the relationship-unfixed block can be obtained, so that the current process is ended.

In the writings DC1 and DC2 have the same relationship as that between the old edition and the revised edition of the same document, it is practically impossible that the degrees of similarity of all the combinations are smaller than the threshold value TH1. For this reason, in many cases, in several combinations, the degree of similarity is the threshold value TH1 or more, and the relationship-fixed block can be obtained. Therefore, in many cases, in a row L21 which is a combination having the highest degree of similarity, a relationship-fixed block can be obtained.

When the threshold value TH1 is set at 40%, in the example shown in FIG. 17, in the combinations of rows L21 to L24, relationship-fixed blocks can be obtained. In the combinations of rows L25 and L26, relationship-unfixed blocks can be obtained.

In a row in which the degree of similarity is the threshold value TH1 or more, YES is determined in step S32. Blocks included in the combination of the row is determined as a relationship-fixed block, and the corresponding block number (relationship block number) is written in a relationship block number column of the structure information table (S33). When the threshold value TH1 is 40%, for example, in the row L21, the block having block number 10 in the revised-edition original writing OR2 and the block having block number 8 in the old-edition original writing OR1 are set as relationship-fixed blocks. In the structure information table in FIG. 4A, in the columns for relationship block number and degree of similarity in a row of block number 8 which is the fourth row from the bottom, block number 10 and the degree of similarity of 100% are written. Similarly, in the structure information table in FIG. 4B, in the columns for relationship block number and degree of similarity in the row of block number 10 which is the lowest-row, block number 8 and the degree of similarity of 100% are written.

With respect to a relationship-unfixed block, any information need not be written in the columns for relationship block number and degree of similarity. However, as needed, predetermined information (relationship-unfixed information) representing a relationship-unfixed block may be written. In this case, when the threshold value TH1 is 40%, the columns for relationship block number and degree of similarity of the blocks (including blocks of combinations (not shown) having the degree of similarity of 0) of combinations in the rows L24 to L26 in FIG. 17, the relationship-unfixed information is written.

For example, with respect to blocks on the old-edition original writing OR1 side, a plurality of blocks having the degrees of similarity which are the threshold value TH1 or more may exist on the revised-edition original writing OR2 side. In such a case, a block having the maximum degree of similarity is selected, and the selected block is preferably set as a relationship-fixed block.

When it is apparent in the step S33 that the degree of similarity of the row L21 is the threshold value TH1 or more, subsequent to the step S33, the row L21 is deleted from the block combination table set in the state in FIG. 17 (S34). It is inspected whether a row is left in the block combination table or not (S35). If YES in step S35, the control flow returns to the step S30. If NO in step S35, the current process is ended (S36).

In inspection in the step S32, when the coefficient p is reflected, the relationship between subsidiary blocks is regulated by the relationship between master block of the original writings OR1 and OR2, and the probability of fixing the relationship of the subsidiary blocks beyond the range of the master blocks (subsidiary block is set as a relationship-fixed block) can be reduced.

In this manner, when the relationship between master blocks is fixed, the relationship between the subsidiary blocks of the master blocks can be easily fixed (more easier than the subsidiary block of the master block which is fixed not to correspond to the master block). Even in a case in which the subsidiary blocks include some sentence which has no relationship, the relationship between the subsidiary blocks is also easily fixed.

With the above processes, all the blocks in the revised-edition original writing OR2, it is determined whether the blocks are relationship-fixed blocks or relationship-unfixed blocks. For this reason, depending on the determination, the translation process section 8 or the difference information generation section 4 can be operated.

The translation process section 8 executes translation by parallel translation in units of blocks (for example, in units of clauses) to the relationship-fixed block in the revised-edition original writing OR2 by replacing blocks in the corresponding old-edition translated writing CP1. The translation process section 8 can execute normal mechanical translation to a relationship-unfixed block in the revised-edition original writing OR2 or can translation by parallel translation in units of sentences to the relationship-unfixed block on the basis of the degree of similarity as in the Non-patent Document 1.

With the above processes, a translation process which frequently uses translation by parallel translation using replacement in units of blocks is performed, so that the revised-edition translated writing CP2 corresponding to the revised-edition original writing OR2 can be obtained.

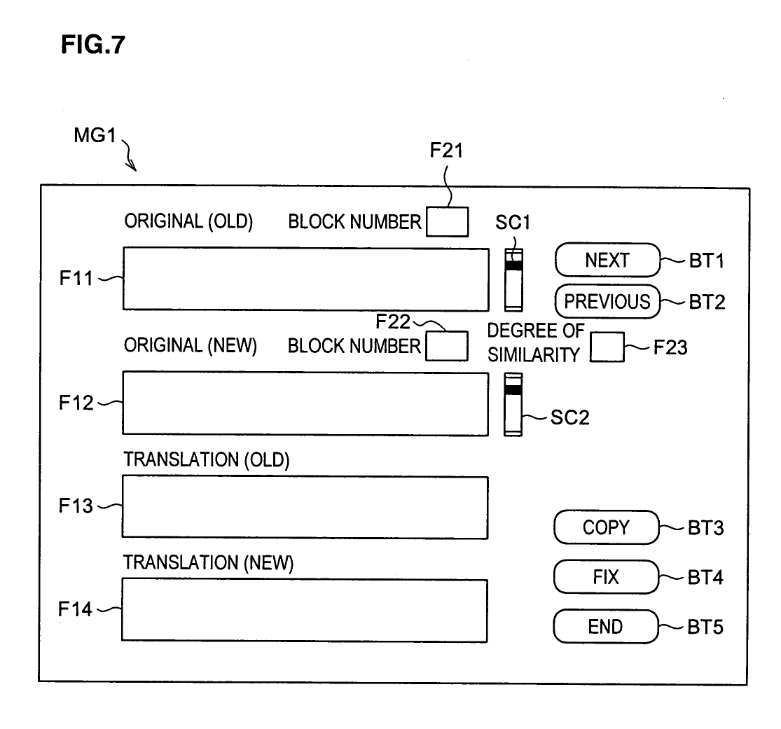

After the revised-edition translated writing CP2, or in the process of obtaining the revised-edition translated writing CP2, a screen MG1 as shown in FIG. 7 is displayed on the display device of the output section 7 to cause the user to perform post edition, or a user interface for independently designating translation by parallel translation can be provided.

On the screen MG1, fields F11 to F14 for displaying character strings of one sentence or a plurality of sentences belonging to each block of an old edition, a revised edition (new edition), an original writing, and a translated writing, fields F21 and F22 for displaying block numbers, scroll bars SC1 and SC2 for scrolling the display contents in the fields F11 to F14, a field F23 for displaying the degree of similarity serving grounds for determining a relationship, and various buttons BT1 to BT5 serving as dialogue components.

When the user operates the pointing device or the like to depress the “next” button BT1, a block in the revised-edition original writing OR2 displayed in the field F12 is switched to the next block (block having block number which is incremented by 1). In contrast to this, when the user depresses the “previous” button BT2, a block in the revised-edition original writing OR2 displayed in the field F12 is switched to the previous block (block having block number which is decremented by 1).

When the character strings of sentences in the old edition and the new edition completely coincide with each other, intuitive marks are given to the character strings. The marks may be displayed on the basis of the auxiliary information. The user can recognize that the sentences completely coincide with each other on the basis of the marks. In addition, in general, when a rate of marked sentences is high, the probability of directly recycling the sentences is high. This means that the necessity of post edition for a translation result obtained by parallel translation is low for this reason, the user can decide whether post edit for the block is necessary or not on the basis of the rate of the marked sentences.

The “copy” button BT3 is depressed when the user reads the blocks in the old-edition original writing OR1 and the block in the revised-edition original writing OR2 which are displayed in the fields F11 and F12 to decide that the blocks have a good relationship. With this depression, the block in the old-edition translated writing CP1 displayed in the field F13 at this time is copied onto the field F14 for displaying the block in the revised-edition translated writing CP2. Therefore, this “copy” button BT3 is component for causing the user to independently designate translation by parallel translation.

When the revised-edition translated writing CP2 is completed, the block (part of translation result) in the revised-edition translated writing CP2 is displayed in the field F14 from the beginning. However, as needed, in the field F14, translated sentences can be displayed one by one.

In any cases, an editing operation (post edit) by the user is mainly executed to a translation result displayed in the field F14.

As has been described above, the old-edition original writing OR1 and the old-edition translated writing CP1 exactly correspond to each other at a sentence level. Similarly, the revised-edition original writing OR2 and the revised-edition translated writing CP2 exactly correspond to each other. Furthermore, although not exactly, the old-edition original writing OR1 and the revised-edition original writing OR2 roughly correspond to each other. Therefore, when the buttons BT1 and BT2 are depressed to switch a block in the revised-edition original writing OR2 displayed in the field F12, basically, blocks displayed in the other fields F12 to F14 are switched to corresponding blocks according to the above switching operation.

The user which reads the screen MG1 selects a desired block on each writing on the basis of a block in the old-edition original writing OR1 to advance the post editing operation. With the selection, when a block (block in the revised-edition translated writing CP2) displayed in the field F14 is directly used, the block may include an inappropriate sentence or word because the contents of the block are changed by revising the edition. For this reason, in the post edition, such a sentence or word is found out and then replaced with an appropriate sentence or word.

The degree of similarity displayed in the field F23 is used as information for notifying the user of a block which has a high necessity of post edition. For example, in general, a block having the degree of similarity of 100% need not be subject to post edit. However, the degree of similarity is low (for example, about 50%), it is understood that the post edition must be performed to the block with emphasis on the block. In addition to the degree of similarity, or in place of the degree of similarity, auxiliary information including the mark is used. In this case, the user can be informed of the necessity of post edit by a visceral method such as a method of using colors of the screen in the field F14 or an inverting display method.

Upon completion of the post edit, when the contents of the block in the revised-edition translated writing CP2 is fixed, the user depresses the “fix” button BT4. Accordingly, the contents of the block are fixed and stored.

When the independent designation of translation by parallel translation is ended, the user depresses the “end” button BT5. Accordingly, as in the block in the old-sentence document DC1, the corresponding block in the revised-edition document DC2 is stored in the old-edition database 5.

Thereafter, when a new revised-edition writing DC3 obtained by revising the edition of the writing DC2 is to be translated, since the writing DC2 is an old-edition document when viewed from the new revised-edition writing DC3, the parallel translation of the revised-edition document DC2 stored in the old-edition database 5 can be used when translation by parallel translation is performed to the new revised-edition writing DC3.

(A-3) Effect of First Embodiment

According to this embodiment, a high-quality translation result faithful to a text can be obtained.

In this embodiment, the operating efficiency of post edit can be improved by using various pieces of information (including the auxiliary information or the like) obtained in the process of performing translation faithful to a text.

(B) Second Embodiment

Only different points between this embodiment and the first embodiment will be described below.

This embodiment has the following characteristic feature. That is when the degree of similarity of a sentence is calculated to determine the relationship between sentences, a sentence near the given sentence is a relationship-fixed sentence, for example, when an adjacent sentence is a relationship-fixed sentence (sentence having fixed relationship) or when near sentences include a large number of relationship-fixed sentences, control is performed such that the degree of similarity of the sentence increases.

(B-1) Configuration and Operation of Second Embodiment

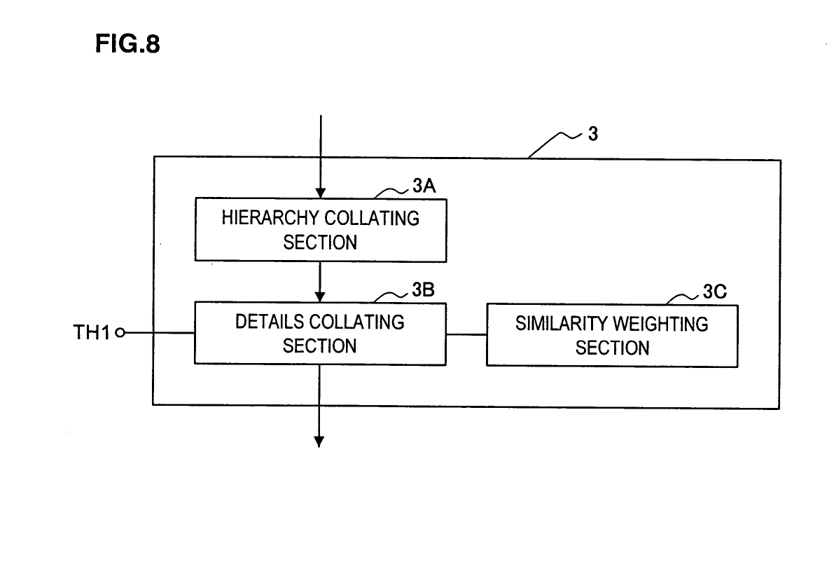

In the configuration, this embodiment is different from the first embodiment, as shown in FIG. 8, in only that a degree-of-similarity weighting section 3C is connected to a details collating section 3B.

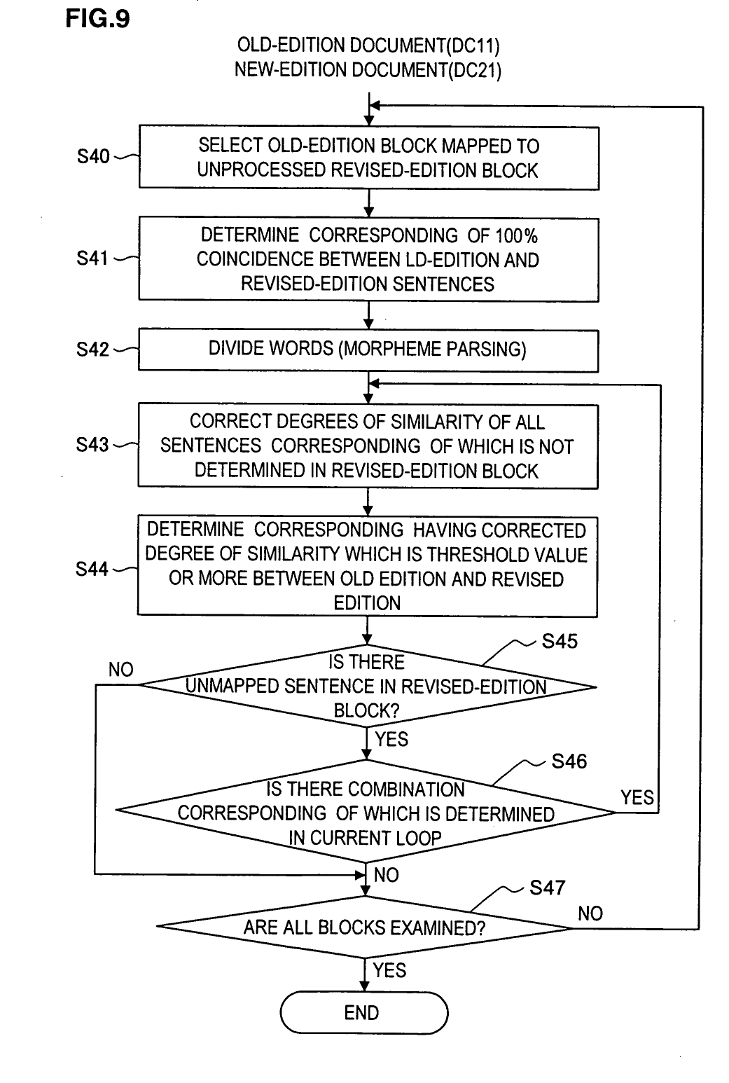

An operation performed when the relationship between sentences in a translation support system 10 according to this embodiment is shown in the flow chart in FIG. 9. The flow chart in FIG. 9 includes steps S40 to S47.

In this embodiment, it is assumed that an old-edition document corresponding to the old-sentence document DC1 is represented by DC11 and that a revised-edition document corresponding to the revised-edition document DC2 is represented by DC21. It is assumed that a block BR1 serving as one block of an old-edition original writing OR11 in the document DC11 include a sentence a, a sentence b, a sentence c, and a sentence d and that a block BR2 serving as one block of the revised-edition original writing OR21 in the document DC21 includes a sentence 1C, a sentence 2C, a sentence 3C, and a sentence 4C. Orders of the sentences appearing in the writings OR11 and OR21 are the orders of the sentences described above. As the sentence 1C in the revised-edition document DC21, the sentence a in the old-edition document DC11 is directly used without changing any character. It is assumed that the other sentences 2C to 4C are changed or added by revising the edition.

It is assumed that, before the step S40, the relationship between blocks in the writings OR11 and OR21 has been determined. In FIG. 9, the relationships between sentences in blocks are determined.

In FIG. 9, relationship-fixed blocks the relationships of which are fixed between the revised-edition original writing OR21 and the old-edition original writing OR1 are selected one by one (S40). In this manner, for example, the blocks BR1 and BR2 are selected.

A combination of sentences in which all the characters coincide with each other is selected between the blocks BR1 and BR2 (S41). A word cut-out process is performed to sentences except for the sentences included in the selected combination (S42). In this step S41, a combination of the sentence 1C and the sentence a is selected. With respect to the combination of the sentence 1C and the sentence a, at this time, the relationship is fixed, and the sentence 1C is set as the relationship-fixed sentence in the revised-edition original writing OR21.

The word cut-out process in step S42 can be performed by, for example, morphological parsing. However, if necessary, a character cut-out process may be performed in place of the word cut-out process.

The word cut-out process is performed to calculate the degree of similarity by equation (2) (to be described later).

In step S43 subsequent to step S42, sentences the relationships of which are not fixed in the block BR2 are selected one by one, the degree of weighting similarity (degree of corrected similarity) based on the next equation (2) is calculated.

WT×100×(the number of coincided words)/((the total number of words of one pair of sentences)/2) (2)

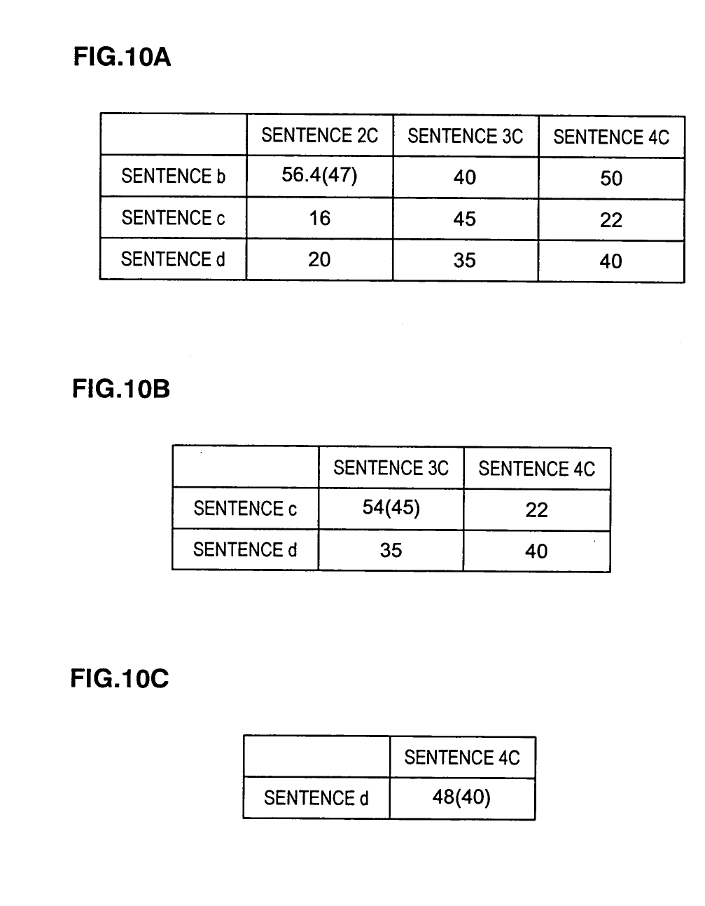

In this equation, reference symbol WT denotes a weight, and its initial value is 1. However, when the relationship between sentences appearing before or after a given sentence in a corresponding writing (in this case, the writing OR21) is determined, the value of the weight WT is changed into a value larger than the initial value. The next value of the initial value may be, e.g., 1.2. A similar change of the value of the weight WT is repeated. When the concentration of relationship-fixed sentences appearing near the given sentence is high, the value of the weight WT is changed into a large value. In contrast to this, sentences (relationship-unfixed sentences) in which it is determined that sentences each having the relationship do not exist near the given sentence appears. When the concentration of the sentences is high, the value of the weight WT may be changed to a small value. However, in the examples in FIGS. 10A to 10C, it is assumed that the weight WT has one of two values, i.e., the initial value of 1 and 1.2. In addition, it is assumed that the value of the weight WT is changed from 1 to 1.2 without considering the concentration or the like when the relationship of a simply adjacent sentence is fixed.

Similarly, the degrees of similarity are calculated for all the combinations which are available between the blocks BR1 and BR2 except for a combination the relationship of which has been determined (for example, a combination of the sentence a and the sentence 1C, or the like).

If the concrete character strings of the sentence 2C and the sentence b are as follows, and if the value of the weight WT is 1, the number of words included in the sentence 2C is 5, and the number of words included in the sentence b is 6. The total number of words of a pair of sentences consisting of the sentence 2C and the sentence b is 11.

Sentence 2C: This is a pencil.

Sentence b: This is a pencil case.

In this case, the number of coincided words is 5. For this reason, the degree of weighting similarity obtained by the equation (2) is 90.9% (≈1×100×5/(11/2)).

A combination in which the degree of weighting similarity is a predetermined threshold value TH1 or more is selected (S44). A concrete value of the threshold value TH1 may be equal to or different from that in the first embodiment. In this case, for example, it is assumed the threshold value TH1 is 50%. The degrees of weighting similarity of combinations of a plurality of sentences on the old-edition original writing OR11 side and the revised-edition original writing OR21 side may be simultaneously the threshold value TH1 or more. However, in such a case, the relationship of only a combination having the maximum degree of weighting similarity is preferably determined.

When the degrees of weighting similarity calculated for the combinations of the sentences 2C to 4C and the sentences b to d are shown in FIG. 10A, only the degree of weighting similarity of the combination of the sentence b and the sentence 2C (in this case, 56.4%) is the threshold value TH1 or more. For this reason, the relationship of the combination is determined, and the sentence 2C is set as a relationship-fixed sentence.

As long as the block BR2 includes a block the relationship of which is not fixed, and as long as a new relationship-fixed sentence is determined by the processes of this loop (loop consisting of steps S43 to S46), the processes in step S43 to S46 are repeated.

Each time the processes are repeated, different sentences are set as a relationship-fixed block sentence. For this reason, a sentence on which the weight WT having a value of 1.2 is reflected changes. For example, in the examples in FIGS. 10A to 10C, in FIG. 10A, the weight WT having a value of 1.2 is used for the sentence 2C adjacent to the sentence 1C which has been a relationship-fixed sentence. The degree of similarity which is 47 when the value of the weight WT is 1 is changed into 56.4 (45 when the weight WT has a value of 1) when the value of the weight WT becomes 1.2. As a result, the degree of similarity is the threshold value TH1 (=50) or more.

Similarly, also in FIG. 10B, when the sentence 2C is set as a relationship-fixed sentence, the sentence 3C adjacent to the sentence 2C is influenced by the weight WT having a value of 1.2, the degree of weighting similarity becomes 54 and is the threshold value TH1 or more. As a result, the sentence 3C is set as a relationship-fixed sentence.

In the last, in FIG. 10C, when the sentence 3C becomes a relationship-fixed sentence, the sentence 4C adjacent to the sentence 3C is influenced by the weight WT having a value of 1.2, and the degree of weighting similarity becomes 48. However, since the value of 48 is not the threshold value TH1 or more, it is determined that the combination of the sentence 4C and the sentence d has no relationship, and the sentence 4C is set as a relationship-unfixed sentence.

Processes similar to the above processes are executed with respect to all the blocks in the revised-edition original writing OR21 (S47).

(B) Effect of Second Embodiment

According to this embodiment, an effect equal to that of the first embodiment can be obtained.

In addition, in this embodiment, since a sentence near (adjacent to) a relationship-fixed sentence has a weighting value which increases, the sentence is easily set as a relationship-fixed sentence. In this manner, even though there is a sentence having a high degree of similarity with respect to one given sentence, the sentence is easily set as a relationship-fixed sentence when the sentences before and after the given sentence are not edited or are slightly edited. Relationship-fixed sentences tend to be continuously generated. This is effective to obtain a translation result faithful to a text.

In contrast to this, when a sentence adjacent to a given sentence is deleted or considerably edited, the degree of similarity of the adjacent sentence relatively decreases. It is true that the connection between the sentences becomes weak. Therefore, in this sense, it is true that this embodiment easily obtains a translation result faithful to a text.

(C) Third Embodiment

Only different points between this embodiment and the first and second embodiment will be described below.

In this embodiment, a user interface is different from that in the first embodiment, and post edit can be more easily performed.

(C-1) Configuration and Operation of Third Embodiment

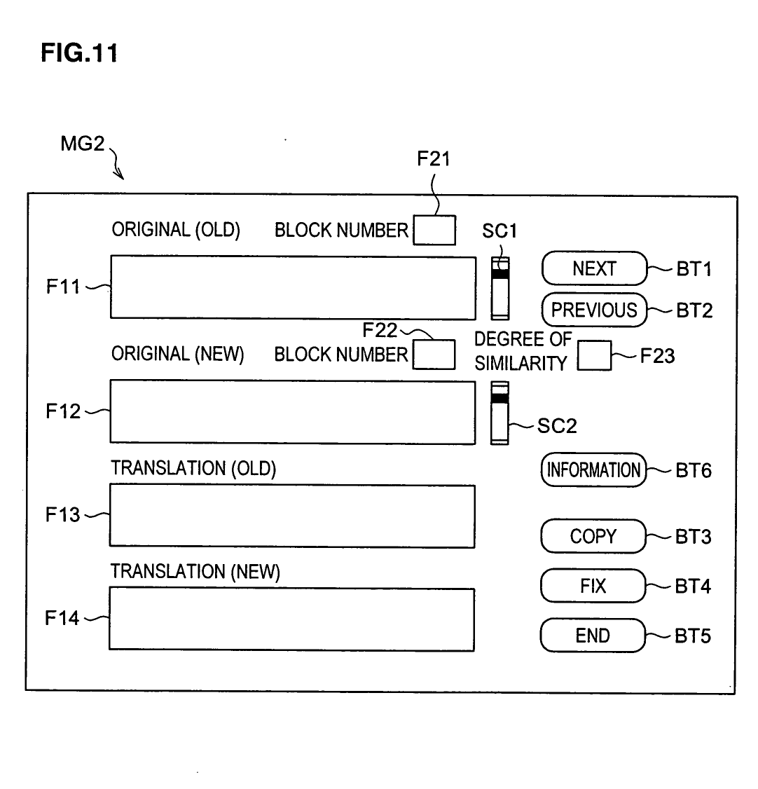

In FIG. 11, in the configuration, this embodiment is mainly different from the first and second embodiments in that an “information” button BT6 is arranged on a screen MG2 corresponding to the screen MG1. The “information” button BT6 is depressed when a user requests to supply information for edit information.

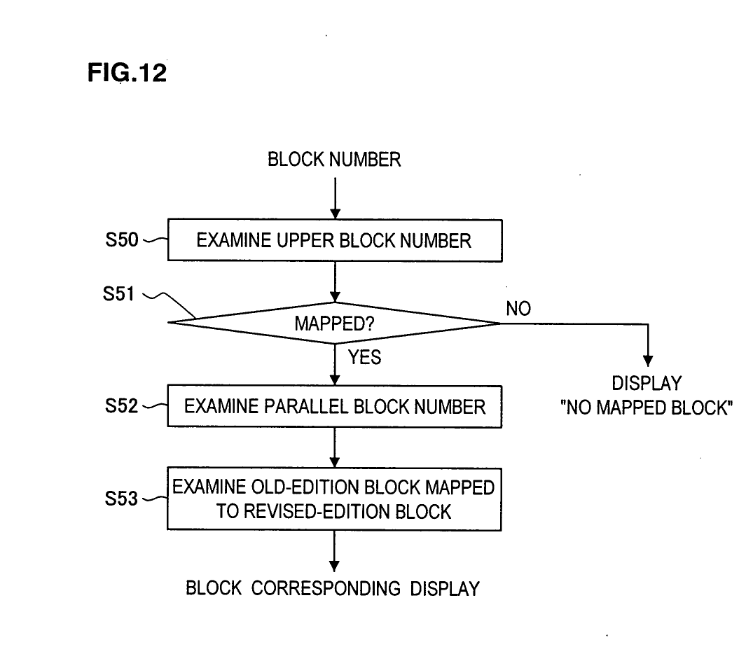

An operation for screen display in a translation support system 10 according to this embodiment is shown in the flow chart in FIG. 12. The flow chart in FIG. 12 has steps S50 to S53).

In FIG. 12, in a state in which desired blocks (subsidiary blocks) are displayed in fields F12 and F14 (as needed, fields F11 and F13 may be used) in which blocks in a revised-edition writing on the screen MG2 in FIG. 11, when the user depresses the “information” button BT6, a block number displayed in a field F21 at this time is supplied to a control section 6. The control section 6 retrieves the block number of an upper block (master block) of a block designated by the block number (S50). This retrieving operation can be easily executed by using the structure information tables shown in FIGS. 4A and 4b.

The master block may be a relationship-fixed block or a relationship-unfixed block. When the master block is the relationship-unfixed block, NO is determined in step S51, and the screen (not shown) in the display device informs the user that the master block is the relationship-unfixed block. This occurs in a case in which the master block is a block added by revising an edition.

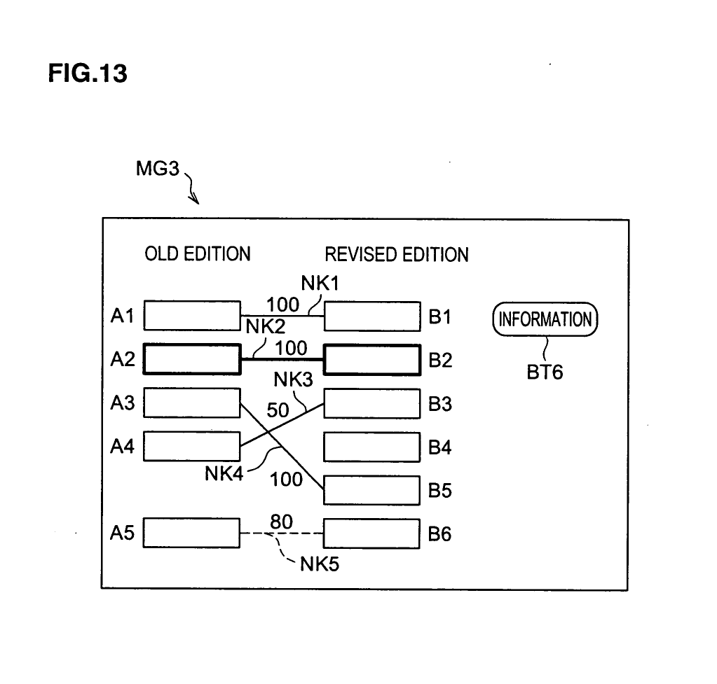

On the other hand, when the master block is a relationship-fixed block, YES is determined in step S51 to retrieve another subsidiary block (parallel block) arranged on the revised-edition writing side and belonging to the same master block (S52). In this case, the revised-edition writing may be a revised-edition original writing, it may be natural that a revised-edit translated writing is used because of the nature of post edit. A similar retrieving operation is also performed on the old-edition writing in which the relationship to the master block is fixed. The relationship between the subsidiary blocks of the revised-edition writing and the old-edition writing (the blocks are relationship-fixed blocks or relationship-unfixed blocks) is examined. When the blocks are relationship-fixed blocks, the degree of similarity serving as grounds for determining the relationship-fixed blocks is displayed. For this purpose, the screen displayed on the display device, for example, the configuration of a screen MG6 shown in FIG. 13 may be used.

On the screen MG6, the parallel blocks are basically displayed. However, as needed, subsidiary blocks belonging to different master blocks may be displayed. In the example in FIG. 13, as will be described below, a block A5 is such a subsidiary block.

In FIG. 13, reference symbols A1 to A5 denote subsidiary blocks on the old-edition writing side, and reference symbols B1 to B6 denote subsidiary blocks on the revised-edition writing side. Corresponding lines NK1 to NK5 which connect blocks on the screen MG3 intuitively shows that the connected blocks are relationship-fixed blocks the relationship of which are fixed. Numbers (100, 50, 80, and the like) displayed near the corresponding lines NK1 to NK5 are the degrees of similarity which are grounds for fixing the relationship.

In general, when the degree of similarity is low, a rate of change caused by revising an edition is high, and the necessity of post edit is high. For this reason, a block subjected to post edit can be selected on the basis of the displayed degree of similarity, and efficient post edit can be performed while giving attention to blocks having low degrees of similarity.

In addition, the positional relationship (alignment) of the relationship-fixed blocks in the old-edition and revised-edition writings can be recognized by the screen MG3, and a target of post edition can be more exactly selected. For example, with respect to the block B2, since the first previous block B1 corresponds to a block A1, it can be determined that the necessity of post edit for the first half of the block B2 is low. However, since the first next block B3 does not correspond to a block A3, it can be determined that the necessity of post edit for the second half of the block B2 is high.

A block B5 which is not connected by any corresponding line is a block which is determined as a new block added by revising the edition. The blocks B2 and A2 indicated by lines thicker than that of another block in FIG. 13 are subsidiary blocks which are displayed in the field F14 of the screen MG2 before the “information” button BT6 is depressed. With this display, the user does not lose a subsidiary block (B2) to which attention is given at the first in the post edit operation.

Blocks connected by the corresponding line NK5 indicated by a dotted line but a solid line have master blocks which do not have relationship. More specifically, the block A5 is a subsidiary block of a master block which is different from the master block of the other blocks Al to A4 in the old-edition writing. In such a case, it is highly possible that the block B6 serving as a translation result obtained by parallel translation is not faithful to the text. For this reason, although the degree of similarity is relatively high, i.e., 80%, it can be determined that the necessity of post edit for the block B6 is high.

In FIG. 13, any information is not displayed in the blocks. However, as needed, the contents of concrete character strings may be displayed. For example, the first sentence belonging to each of the blocks is desirably displayed in the corresponding block.

The screen MG2 is displayed again, blocks displayed in the fields F11 to F14 are changed on the screen MG2, and the “information” button BT6 is depressed. In this case, the processes of the flow chart in FIG. 12 can be naturally performed at different hierarchies.

(C-2) Effect of Third Embodiment

According to this embodiment, effects equal to those in the first and second embodiment can be achieved.

In addition, in this embodiment, change information (for example, the corresponding lines NK1 to NK4 (NK5), the degrees of similarity displayed near the corresponding lines, and the like) covering the entire range of upper blocks (master block or the like to which the subsidiary blocks B1 to B4 belong) to which the subsidiary block (for example, B2) belongs can be displayed. For this reason, the entire difference between the old-edit writing and the revised-edit writing is easily understood, and a post editing operation faithful to the text can be easily performed.

A spreading manner of the influence of change by revising an edition can be intuitively surveyed. For this reason, time required for post edit can be estimated.

(D) Fourth Embodiment

Only different points between this embodiment and the first to third embodiments will be described below.

In the first to third embodiment, the relationship between blocks is automatically determined by a translation support system. However, in this embodiment, the relationship (relationship-fixed block) between blocks automatically fixed by a translation support system is verified by a user. As needed, the user can change the relationship.

(D-1) Configuration and Operation of Fourth Embodiment

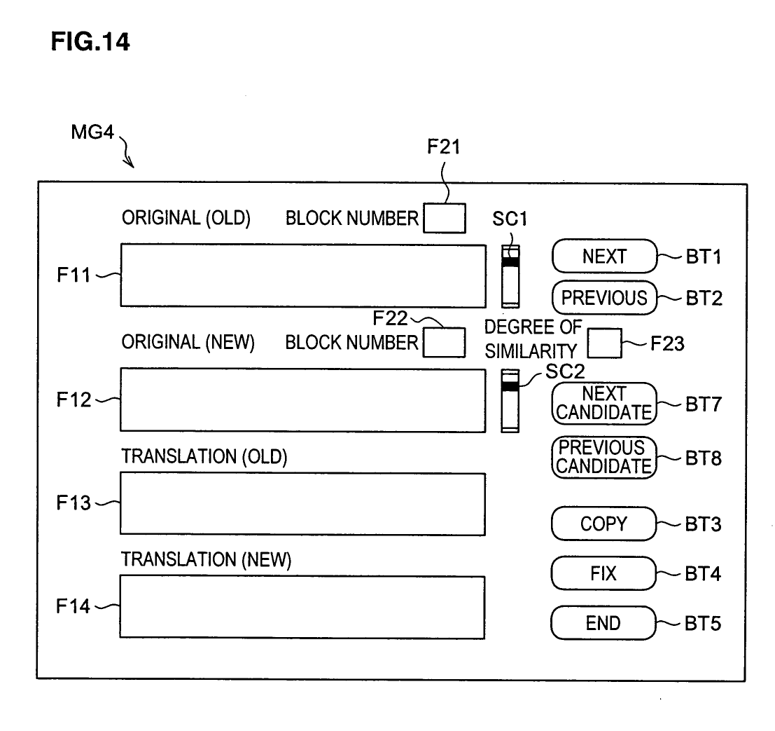

In the configuration, this embodiment is mainly different from the first to third embodiments in a screen MG4 shown in FIG. 14. The screen MG4 is a screen corresponding to the screen MG1. However, the screen MG4 is different from the screen MG1 in that the screen MG4 has a “next candidate” button BT7 and a “previous candidate” button BT8.

The “next candidate” button BT7 and the “previous candidate” button BT8 are buttons for selecting new relationship-fixed blocks when the user changes relationship-fixed blocks. Blocks on the revised-edition writing side corresponding to blocks in the old-edition writing side are accumulated in the translation support system 10 as a block corresponding table in the form of an alignment made on the basis of the degrees of similarity of the blocks.

The block corresponding table may be, for example, a table similar to the block combination table shown in FIG. 17. However, the table stores only combinations of blocks having the degrees of similarity which are the threshold value TH1 or more. The combination table in FIG. 17 is a table in which arbitrary combinations at the same hierarchy position are simply aligned depending on the degrees of similarity. However, in the block corresponding table, blocks are arranged in units of blocks on the old-edition writing side, the blocks on the revised-edit writing side are aligned depending on the degrees of similarity.

However, the table shown in FIG. 17 can be utilized as a block corresponding table depending on a manner of generation of retrieval conditions for the table.

In short, a plurality of candidates (candidate blocks) of the blocks arranged on the revised-edition writing side and having the relationships to the blocks on the old-edition writing side are prepared, one of the candidate blocks is selected depending on an instruction from the user, so that the combinations of the blocks can be changed.

In the first embodiment, when a relationship block number is written in the structure information table in step S33 in the flow chart shown in FIG. 6, for example, when the blocks on the revised-edition original writing OR2 side include a plurality of blocks having the degrees of similarity which are the threshold value TH1 or more with respect to the block on the old-edition original writing OR1 side, a block having the maximum degree of similarity is selected as a relationship-fixed block. In the fourth embodiment, the block numbers of blocks which are not selected in this selection are stored as candidate block numbers.

When the user reads the screen MG4 shown in FIG. 14 depresses the “next candidate” button BT7, for example, a block number displayed in the field F22 at this time is supplied to the control section 6. The control section 6 perform retrieval for the block corresponding table on the basis of the block number. As the retrieval result, the user obtains the block numbers of blocks having the second and subsequent highest degrees of similarity. The main bodies of the blocks corresponding to the block numbers are obtained from the old-edition database 5 and displayed in a corresponding field (e.g., F12) on the screen MG4. At this time, the block number of the corresponding block is displayed in the field (e.g., F22).

Subsequently, the same processes as described above can be repeated.

Each time the user depresses the “next candidate” button BT7, the user can read a candidate block having a lower degree of similarity. Each time the user depresses the “previous candidate” button BT8, the user can read a candidate block (including an original relationship-fixed block) having a higher degree of similarity. For this reason, the user herself/himself can determine an optimum block as the relationship-fixed block.

When the relationship-fixed blocks are changed by the determination of the user, the contents of the revised-edition translated writing CP2 are also changed.

(D-2) Effect of Fourth Embodiment

According to this embodiment, effects equal to those in the first to third embodiments can be achieved.

In addition, in this embodiment, the relationship between blocks automatically fixed by a translation support system (10) is verified by a user (U1). As needed, the user (U1) can also change relationships. This improves the usability of the translation support system (10), and contributes to improvement in quality of a translation result obtained by parallel translation.

(E) Another Embodiment

In the first to fourth embodiments, although concrete configurations of a large number of screens are illustrated, a screen having a configuration except for the above configurations may be used as a matter of course.

In the second embodiment, the case in which, when an adjacent sentence is a relationship-fixed sentence, the degree of similarity of the sentence is increased is mainly explained. However, it is easy that this process can be extensionally applied to a case in which near sentences include a large number of relationship-fixed sentences or a case in which a sentence near the sentence is a relationship-fixed sentence to increase the degree of similarity of the sentence.

In the first to fourth embodiments, although a block of a paragraph is neglected, a process may be performed in consideration of a paragraph as a matter of course.

A sentence described in the second embodiment can be replaced with a block. More specifically, when an adjacent block is a relationship-fixed block, or when near blocks include a large number of relationship-fixed blocks, control may be performed to increase the degree of similarity of the block.

Translation is not necessarily performed regardless of the first to fourth embodiments. The present invention can also be applied to the following case. That is, the relationship between blocks is detected, and detailed edition management for a manual or the like is performed by using a text (including a case in which information related to a detailed difference between an old-edition document and a revised-edition document). The present invention can be applied to not only edition management but also a case the relationship between blocks in documents.

In addition, the document may include constituent elements except for natural language. For example, the present invention can also be applied to a document including a graphic, an image, or the like. A graphic, an image, or the like can contribute to formation of a text in a document as a matter of course.

The document may include a language (e.g., a programming language or the like). Like the manual, a technical document, or an article, a document written by a source code of a computer program written in a programming language is a typical example of a document the edition of which is to be frequently revised.

In the above description, the present invention is realized in hardware. However, the present invention can also be realized in software.

As described above, according to the present invention, the relationship between documents can be detected in consideration of the texts of the documents.

Therefore, for example, the quality of edition management or the quality of a translation process using a parallel-translation dictionary can also be improved.

1. A document relationship inspection apparatus which inspects the relationship between constituent elements of a first document and constituent elements of a second document, comprising:
a logical structure parsing section which parses a logical structure of a sentence block including at least one sentence in the constituent elements of the first document and which parses a logical structure of a sentence block including at least one sentence in the constituent elements of the second document; and
a relationship detection section which detects the relationship between the sentence block of the first document and the sentence block of the second document on the basis of a parsing result from the logical structure parsing section.

2. A document relationship inspection apparatus according to claim 1, wherein
the relationship detection section
when sentence blocks of the same document have a hierarchical structure, detects the relationship related to the sentence block at an upper hierarchy and then detects the relationship of a sentence block at a lower hierarchy.

3. A document relationship inspection apparatus according to claim 1, wherein
the relationship detection section
comprises a first degree-of-similarity calculation section which calculates a predetermined degree of similarity between a sentence block related to the first document and a sentence block related to the second document,
when the sentence blocks of the same document have a hierarchical structure, the relationship of a block having a higher degree of similarity in sentence blocks at the same hierarchy is preferentially detected, and the first degree-of-similarity detection section is controlled to increase the degree of similarity of a sentence block which is near the sentence block the relationship of which is detected in the document.

4. A translation process apparatus which uses a parallel-translation dictionary in which a parallel translation between original sentences and translated sentences in a first document is registered to perform a translation process of an original of a second document serving as a revised-edition document obtained by changing at least a part of the first document, comprising:
a document relationship inspection apparatus according to claim 1; and
a block translation process section which executes a translation process using the parallel-translation dictionary to at least a sentence block the relationship of which is detected by the document relationship inspection apparatus in sentence blocks included in an original related to the second document.

5. A translation process apparatus according to claim 4, comprising
a first difference information display section which, when a translation result of the sentence block the relationship of which is detected by the document relationship inspection apparatus is displayed, first difference information representing a difference between the originals of the first document and the second document.

6. A translation process apparatus according to claim 4, comprising
a second difference information display section which, when sentence blocks of the same document has a hierarchical structure, displays second difference information representing a difference between a sentence block of an upper hierarchy to which the sentence block the relationship of which is detected by the document relationship inspection apparatus belongs and the original of the first document.

7. A translation process apparatus according to claim 4, comprising:
a second degree-of-similarity calculation section which calculates a predetermined degree of similarity between the sentence block of the original related to the first document and the sentence block of the original related to the second document; and
a corresponding candidate process section which stores, as corresponding candidate blocks, sentence blocks the degrees of similarity of which are detected by the second degree-of-similarity and which are not less than a predetermined threshold value to display the sentence blocks depending on dialogue with a user.

8. A document relationship inspection method which inspects the relationship between constituent elements of a first document and constituent elements of a second document, comprising the steps of:
parsing a logical structure of a sentence block including at least one sentence in the constituent elements of the first document and parsing a logical structure of a sentence block including at least one sentence in the constituent elements of the second document; and
detecting the relationship between the sentence block of the first document and the sentence block of the second document on the basis of a parsing result from the logical structure parsing section.

9. A document relationship inspection method according to claim 8, wherein
the relationship detection section
when sentence blocks of the same document have a hierarchical structure, detects the relationship related to the sentence block at an upper hierarchy and then detects the relationship of a sentence block at a lower hierarchy.

10. A document relationship inspection method according to claim 8, wherein
in the relationship detection section,
a first degree-of-similarity calculation section calculates a predetermined degree of similarity between a sentence block related to the first document and a sentence block related to the second document,
when the sentence blocks of the same document have a hierarchical structure, the relationship of a block having a higher degree of similarity in sentence blocks at the same hierarchy is preferentially detected, and the first degree-of-similarity detection section is controlled to increase the degree of similarity of a sentence block which is near the sentence block the relationship of which is detected in the document.

11. A translation process method which uses a parallel-translation dictionary in which a parallel translation between original sentences and translated sentences in a first document is registered to perform a translation process of an original of a second document serving as a revised-edition document obtained by changing at least a part of the first document, comprising the steps of:
detecting the relationship between a sentence block included in an original related to the second document and a sentence block of an original related to the fist document by a document relationship inspection method according to claim 8; and
causing a block translation process section to execute a translation process using the parallel-translation dictionary to at least a sentence block the relationship of which is detected by the document relationship inspection method in sentence blocks included in the original related to the second document.

12. A translation process method according to claim 11, comprising
a first difference information display section which, when a translation result of the sentence block the relationship of which is detected by the document relationship inspection method is displayed, first difference information representing a difference between the originals of the first document and the second document.

13. A translation process method according to claim 11, comprising
a second difference information display section which, when sentence blocks of the same document have a hierarchical structure, displays second difference information representing a difference between a sentence block of an upper hierarchy to which the sentence block the relationship of which is detected by the document relationship inspection method belongs and the original of the first document.

14. A translation process method according to claim 11, wherein
a second degree-of-similarity calculation section calculates a predetermined degree of similarity between the sentence block of the original related to the first document and the sentence block of the original related to the second document, and
sentence blocks the degrees of similarity of which are detected by the second degree-of-similarity and which are not less than a predetermined threshold value are stored as corresponding candidate blocks to display the sentence blocks depending on dialogue with a user.

15. A document relationship inspection program which inspects the relationship between constituent elements of a first document and constituent elements of a second document, causing a computer to realize
a logical structure parsing function which parses a logical structure of a sentence block including at least one sentence in the constituent elements of the first document and which parses a logical structure of a sentence block including at least one sentence in the constituent elements of the second document; and
a relationship detection function which detects the relationship between the sentence block of the first document and the sentence block of the second document on the basis of a parsing result from the logical structure parsing section.
